(19) United States
(12) Patent Application Publication
(10) Pub. No.: US 2007/0140667 A1
(43) Pub. Date: Jun. 21, 2007

(54) REPRODUCING APPARATUS, REPRODUCING METHOD, REPRODUCING PROGRAM, RECORDING MEDIUM, DATA STRUCTURE, AUTHORING APPARATUS, AUTHORING METHOD, AND AUTHORING PROGRAM

(75) Inventor: Kouichi Uchimura, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Sony Corporation, Shinagawa-ku (JP)

(21) Appl. No.: 11/611,489

(22) Filed: Dec. 15, 2006

(30) Foreign Application Priority Data
Dec. 20, 2005 (JP) 2005-367186

(51) Int. Cl. H04N 5/00

(52) U.S. Cl. 386/125

(57) ABSTRACT

A reproducing device which reproduces contents data recorded on a disc-shaped recording medium is disclosed. The reproducing device includes: an input unit which inputs data including at least the contents data, button images capable of displaying animations of buttons used in an operation screen that prompts a user to perform an operation, and display control information for the button images, the contents data, the button images and the display control information are reproduced from the recording medium; an operation input unit which receives the user operation; and a display controller which controls a display of the animations of the button images on the basis of the display control information.

### CROSS REFERENCES TO RELATED APPLICATIONS

The invention contains subject matter related to Japanese Patent Application JP 2005-367186 filed in the Japanese Patent Office on Dec. 20, 2005, the entire contents of which are incorporated herein by reference.

### BACKGROUND OF THE INVENTION

1. Field of the Invention

The invention relates to a reproducing apparatus, a reproducing method, a reproducing program, a recording medium, a data structure, an authoring apparatus, an authoring method, and an authoring program that improve user operability for interactive operation of a program recorded on a large capacity recording medium such as a blu-ray disc.

2. Background Art

In recent years, as a standard for a recordable disc type recording medium that is detachable from a recording and reproducing apparatus, blu-ray disc standard has been proposed. The blu-ray disc standard prescribes a disc that has a recording medium having a diameter of 12 cm and a cover layer having a thickness of 0.1 mm. The blu-ray disc standard uses a bluish-purple laser having a wavelength of 405 nm and an objective lens having a numerical aperture of 0.85. The blu-ray disc standard accomplishes a recording capacity of 27 GB (Giga bytes) maximum. As a result, a program of a broadcasting satellite (BS) digital high-vision broadcast available in Japan can be recorded for two hours or longer without deterioration of picture quality.

As sources (supply sources) of audio/video (AV) signals recorded on the recordable optical disc, an analog signal of for example a known analog television broadcast and a digital signal of for example a digital television broadcast such as a BS digital broadcast will be used. The blu-ray disc standard has established a method of recording AV signals of such broadcasts.

Meanwhile, as a derivative standard of the current blu-ray disc standard, a reproduction-only recording medium on which a movie, music, or the like is prerecorded is being developed. As a disc-shaped recording medium on which a movie or music is prerecorded, a digital versatile disc (DVD) has been widely used. However, the reproduction-only optical disc in accordance with the blu-ray disc standard is largely different from and superior to the known DVD in a large recording capacity and a high speed transfer speed that allow a high-vision picture to be recoded for two hours or longer in high quality.

When recording contents such as a movie on a disc and selling the recorded disc as package media, a user interface for controlling execution of various programs required by the contents is recorded on the disc together with the contents. A menu display is a typical example of the user interface. For example, in the menu display, buttons for selecting functions are provided as button images, and the buttons are selected by a predetermined input unit, whereby corresponding functions assigned to the buttons are activated. Generally, when one button displayed on a screen is selected by an arrow key in a remote controller corresponding to a player and OK key is pressed, a corresponding function assigned to the button is activated.

JP-A-2004-304767 discloses a technology for realizing the menu display in the Blu-ray disc by using the button images.

However, the Blu-ray disc has a larger recording capacity and uses a high-functional programming language or script language, compared with the known DVD or the like. Moreover, the recorded contents themselves are recorded with high quality, compared with those contents recorded on the known DVD. Therefore, in the menu display described above, it is contemplated to improve user operability and increase added-value by displaying animations of the button images, for example.

A method of displaying animations of the button images proposed in the current standard will be briefly explained. FIGS. 30A to 30D show exemplary animations of the buttons. In the examples of FIGS. 30A to 30D, the animations are displayed on the basis of a lighting state and a non-lighting state of the button images. In FIGS. 30A to 30D, the button images with hatched lines represent the button images in a lighting state and a density of the hatched lines represents brightness of the lighting.

As a simpler example of the animation display of the buttons, two kinds of animations such as (1) blinking and (2) fade-in or fade-out are considered. FIG. 30A corresponds to the case of (1) blinking. A lighting state and a non-lighting state of the button image are repeated with the lapse of time.

FIGS. 30B and 30C show the cases of (2) fade-in and fade-out. FIG. 30B corresponds to the case of fade-in, in which the button image is gradually changed from the non-lighting state to the lighting state with the lapse of time and remains in the lighting state. FIG. 30C corresponds to the case of fade-out, in which the button image is gradually changed from the lighting state to the non-lighting state with the lapse of time and remains in the non-lighting state. A repeat display as shown in FIG. 30D may be performed. In the case of FIG. 30D, the button image is gradually changed from the non-lighting state to the lighting state and from the lighting state to the non-lighting state. The repeat display can be performed in the blinking display of FIG. 30A.

Meanwhile, as a state of the button, there are generally defined three states, such as a selected state where the button is in a selected state, an activated state where a corresponding function of the selected button is to be activated, and a normal state where the button is not in the selected state and the activated state. The state of player is also changed in accordance with the three states of the button.

### SUMMARY OF THE INVENTION

A case where a user has instructed to change the state of button in the process of displaying animation of the button image will be considered.

According to a standard that can be applied to a reproduction-only disc (BD-ROM: Blu-ray Disc-Read Only Memory) in the known Blu-ray disc, as an operation of the player which is instructed to change state thereof in the process of displaying animation, the following two kinds of operations are defined.

(1) The state of the player is changed after displaying the whole movements defined in the animation display (hereinafter, referred to as a first operation).

(2) The state of the player is changed after stopping to display the movements of animation at time of receiving an instruction for changing the states (hereinafter, referred to as a second operation).

An author who creates contents to be included in the BD-ROM was not able to select which one of the first and second operations since the selection of the first and second operations are dependent on implementation of the player. Therefore, when the animation display shown in FIGS. 30A to 30D is used, the user may be confused with the display depending on the timing of the user input, thereby causing an inconvenience to a user operation.

A specific example of such a problem will be described. As a first example, a case where the player is implemented with the second operation and the button image is displayed with the fade-in and fade-out animations will be described. For example, a button which is defined such that the fade-in display is performed when the button image is changed from the normal state to the selected state and the fade-out display is performed when the button image is changed from the selected state to the normal state will be considered.

As shown in FIGS. 31A and 31B, the button image fades-in and fades-out with four levels of brightness between a first brightness level that is the lowest brightness level and a fourth brightness level this is the highest brightness level. When the state of the button is changed from the normal state to the selected state and then changed from the selected state to the normal state at the time of a second brightness level, for example, in the process of the fade-in display as shown in FIG. 31A, the animation display is stopped at the second brightness level and changed to the fade-out display in the case of the second operation. Then, as shown in FIG. 31B, the display of the button image is abruptly changed from the second brightness level to the fourth brightness level corresponding to the first level of the fade-out display, thereby resulting in extremely unnatural display.

As a second example, a case where the player is implemented with the first operation and the button image is displayed with the blinking animations will be described. For example, a button which is defined such that no animation is displayed in the normal state and the blinking animation is displayed in the selected state and the animation display is performed with a total of seven comas between the lighting state and the non-lighting state as shown in FIG. 32A will be considered.

In this case, when there is an input for changing the state of the button, which are displayed with blinking animation in the selected state, from the selected state to the normal state at the time of a third coma of the blinking display, the animation display is performed up to a seventh coma and then the state of the button is changed to the normal state in accordance with the input in the case of the first operation (see FIG. 32B for reference). In this case, there is a problem in that the user input is not received at the time of between the third coma of the blinking display where there was the input and the seventh coma of the blinking display where the animation display is completed.

In addition, since the author and a disc producer cannot select the implementation of the player, in order to avoid the above-mentioned problems, it is necessary to create an animation display which does not cause any problem even when the animation is displayed in a player implemented with the first operation and a player implemented with the second operation, thereby imposing a severe restriction to a disc production.

In view of the above-mentioned situations, there is a need for a reproducing apparatus, a reproducing method, a reproducing program, a recording medium, a data structure, an authoring apparatus, an authoring method, and an authoring program that improve user operability for interactive operation of a program recorded on a large capacity recording medium such as a blu-ray disc.

According to a first embodiment of the invention, there is provided a reproducing device which reproduces contents data recorded on a disc-shaped recording medium, the reproducing device including: an input unit which inputs data including at least the contents data, button images capable of displaying animations of buttons used in an operation screen that prompts a user to perform an operation, and display control information for the button images, the contents data, the button images and the display control information are reproduced from the recording medium; an operation input unit which receives the user operation; and a display controller which controls a display of the animations of the button images on the basis of the display control information, wherein the display control information includes an animation display control flag indicating whether to stop displaying the animations of the button images when the user has instructed to change states of the buttons corresponding to the button images in the process of displaying the animations of the button images, and wherein the display controller stops displaying the animations of the button images in accordance with the indication of the animation display control flag when receiving the user's operation for changing the states of the buttons corresponding to the button images from the operation input unit in the process of displaying the animations of the button images.

According to a second embodiment of the invention, there is provided a reproducing method of reproducing contents data recorded on a disc-shaped recording medium, including the steps of: inputting data including at least the contents data, button images capable of displaying animations of buttons used in an operation screen that prompts a user to perform an operation, and display control information for the button images, the contents data, the button images and the display control information are reproduced from the recording medium; receiving the user operation; and controlling animation display of the button images on the basis of the display control information, wherein the display control information includes an animation display control flag indicating whether to stop displaying the animations of the button images when the user has instructed to change states of the buttons corresponding to the button images in the process of displaying the animations of the button images, and wherein the controlling stops displaying the animations of the button images in accordance with the indication of the animation display control flag when receiving the user's operation for changing the states of the buttons corresponding to the button images in the receiving in the process of displaying the animations of the button images.

According to a third embodiment of the invention, there is provided a reproducing program for causing a computer device to execute a reproducing method of reproducing contents data recorded on a disc-shaped recording medium, the reproducing method including the steps of: inputting data including at least the contents data, button images capable of displaying animations of buttons used in an operation screen that prompts a user to perform an operation, and display control information for the button images, the contents data, the button images and the display control information are reproduced from the recording medium; receiving the user operation; and controlling animation display of the button images on the basis of the display control information, wherein the display control information includes an animation display control flag indicating whether to stop displaying the animations of the button images when the user has instructed to change states of the buttons corresponding to the button images in the process of displaying the animations of the button images, and wherein the controlling stops displaying the animations of the button images in accordance with the indication of the animation display control flag when receiving the user's operation for changing the states of the buttons corresponding to the button images in the receiving in the process of displaying the animations of the button images.

According to a fourth embodiment of the invention, there is provided a disc-shaped recording medium on which contents data has been recorded, wherein at least the contents data, button images capable of displaying animations of buttons used in an operation screen that prompts a user to perform an operation, and display control information for the button images are recorded on the recording medium, and wherein the display control information includes an animation display control flag indicating whether to stop displaying the animations of the button images when the user has instructed to change states of the buttons corresponding to the button images in the process of displaying the animations of the button images.

According to a fifth embodiment of the invention, there is provided a data structure which includes at least contents data, button images capable of displaying animations of buttons used in an operation screen that prompts a user to perform an operation, and display control information for the button images, wherein the display control information includes an animation display control flag indicating whether to stop displaying the animations of the button images when the user has instructed to change states of the buttons corresponding to the button images in the process of displaying the animations of the button images.

According to a sixth embodiment of the invention, there is provided an authoring device which creates contents data to be recorded on a disc-shaped recording medium, the authoring device including: a data creating unit which creates a data structure including at least the contents data, button images capable of displaying animations of buttons used in an operation screen that prompts a user to perform an operation, and display control information for the button images, wherein the data creating unit allows the display control information to include an animation display control flag indicating whether to stop displaying the animations of the button images when the user has instructed to change states of the buttons corresponding to the button images in the process of displaying the animations of the button images.

According to a seventh embodiment of the invention, there is provided an authoring method of creating contents data to be recorded on a disc-shaped recording medium, the authoring method including the steps of: creating a data structure including at least the contents data, button images capable of displaying animations of buttons used in an operation screen that prompts a user to perform an operation, and display control information for the button images, wherein the creating allows the display control information to include an animation display control flag indicating whether to stop displaying the animations of the button images when the user has instructed to change states of the buttons corresponding to the button images in the process of displaying the animations of the button images.

According to an eighth embodiment of the invention, there is provided an authoring program for causing a computer device to execute an authoring method of creating contents data to be recorded on a disc-shaped recording medium, the authoring method including the step of: creating a data structure including at least the contents data, button images capable of displaying animations of buttons used in an operation screen that prompts a user to perform an operation, and display control information for the button images, wherein the creating allows the display control information to include an animation display control flag indicating whether to stop displaying the animations of the button images when the user has instructed to change states of the buttons corresponding to the button images in the process of displaying the animations of the button images.

As described above, according to the first to third embodiments, there are inputted at least the contents data, button images capable of displaying animations of buttons used in an operation screen that prompts a user to perform an operation, and display control information for the button images, which are reproduced from the recording medium, the display control information includes an animation display control flag indicating whether to stop displaying the animations of the button images when the user has instructed to change states of the buttons corresponding to the button images in the process of displaying the animations of the button images, and it is controlled to continue or stop to display the animations of the button images in accordance with the indication of the animation display control flag when receiving the user's operation for changing the states of the buttons corresponding to the button images from the operation input unit in the process of displaying the animations of the button images. Accordingly, it is possible for a contents producer to control the display of the animations of the button images when receiving the user's operation for changing the states of the buttons in the process of displaying the animations.

Moreover, according to the fourth embodiment, at least the contents data, button images capable of displaying animations of buttons used in an operation screen that prompts a user to perform an operation, and display control information for the button images are recorded on the recording medium, and the display control information includes an animation display control flag indicating whether to stop displaying the animations of the button images when the user has instructed to change states of the buttons corresponding to the button images in the process of displaying the animations of the button images. Accordingly, it is possible for a contents producer to control the display of the animations of the button images in a reproduction side of the recording medium when receiving the user's operation for changing the states of the buttons in the process of displaying the animations.

Further, according to the fifth embodiment, a data structure includes at least contents data, button images capable of displaying animations of buttons used in an operation screen that prompts a user to perform an operation, and display control information for the button images, and the display control information includes an animation display control flag indicating whether to stop displaying the animations of the button images when the user has instructed to change states of the buttons corresponding to the button images in the process of displaying the animations of the button images. Accordingly, it is possible for a contents producer to control the display of the animations of the button images in a reproduction side of the recording medium having data of the data structure recorded thereon when receiving the user's operation for changing the states of the buttons in the process of displaying the animations.

In addition, according to the sixth to eighth embodiments, the authoring device which creates contents data to be recorded on a disc-shaped recording medium is operable to create a data structure including at least the contents data, button images capable of displaying animations of buttons used in an operation screen that prompts a user to perform an operation, and display control information for the button images and to allow the display control information to include an animation display control flag indicating whether to stop displaying the animations of the button images when the user has instructed to change states of the buttons corresponding to the button images in the process of displaying the animations of the button images. Accordingly, it is possible for a contents producer to control the display of the animations of the button images in a reproduction side of the recording medium having the created data recorded thereon when receiving the user's operation for changing the states of the buttons in the process of displaying the animations.

Therefore, according to the above-mentioned embodiments of the invention, since the display control information of the button images includes an animation display control flag indicating whether to stop displaying the animations of the button images when the user has instructed to change states of the buttons corresponding to the button images in the process of displaying the animations of the button images, it is possible for a contents producer to control the display of the animations of the button images in a reproduction side when receiving the user's operation for changing the states of the buttons in the process of displaying the animations.

### BRIEF DESCRIPTION OF THE DRAWINGS

FIG. 1 is a schematic diagram showing a data model of BD-ROM.

FIG. 2 is a schematic diagram for explaining an index table.

FIG. 3 is a UML diagram showing the relation of a clip AV stream, clip information, a clip, a play item, and a play list.

FIG. 4 is a schematic diagram for explaining a method of referencing identical clips from a plurality of play lists.

FIG. 5 is a schematic diagram for explaining a sub path.

FIG. 6 is a schematic diagram for explaining a management structure of files recorded on a recording medium.

FIGS. 7A and 7B are flowcharts showing outlined operations of a BD (Blue-ray Disc) virtual player.

FIGS. 8A and 8B are flowcharts showing outlined operations of a BD virtual player.

FIG. 9 is a schematic diagram showing an exemplary plane structure used as a display system of a picture according to an embodiment of the invention.

FIG. 10 is a schematic diagram showing examples of resolutions and displayable colors of a moving picture plane, a subtitle plane, and a graphics plane.

FIG. 11 is a block diagram showing an exemplary structure that combines the moving picture plane, the subtitle plane, and the graphics plane.

FIG. 12 is a schematic diagram showing an example of input and output data of a palette.

FIG. 13 is a schematic diagram showing an exemplary palette table held in the palette.

FIG. 14 is a schematic diagram showing an exemplary menu screen displayed on the graphics plane.

FIG. 15 is a schematic diagram showing an exemplary state change of a button that is displayed on the graphics plane.

FIGS. 16A to 16F are schematic diagrams showing outlined structures of a menu screen and buttons.

FIGS. 17A to 17D are schematic diagrams for explaining examples of storing formats of button images.

FIG. 18 is a table showing syntax that describes an exemplary structure of header information of an ICS (Interactive Composition Segment).

FIG. 19 is a table showing syntax that describes an exemplary structure of a block interactive_composition_data_fragment( ).

FIG. 20 is a table showing syntax that describes an exemplary structure of a block page( ).

FIG. 21 is a table showing syntax that describes an exemplary structure of a block button_overlap_group( ).

FIG. 22 is a table showing syntax that describes an exemplary structure of a block button( ).

FIG. 23 is a block diagram showing an example of the configuration of a reproducing apparatus to which an embodiment of the invention can be applied.

FIG. 24 is a flowchart showing an example of processes that are performed until a displayed menu screen is removed after acquiring IG stream.

FIG. 25 is a flowchart showing a specific example of processes in “UO (User Operation) routine”.

FIG. 26 is a flowchart showing a specific example of processes in “selection_time_out routine”.

FIG. 27 is a flowchart showing a specific example of processes in “user_time_out routine”.

FIG. 28 is a schematic diagram showing an example of a disc manufacturing process.

FIG. 29 is a block diagram showing an example of the arrangement of a software creating unit.

FIGS. 30A to 30D are schematic diagrams for explaining a problem in a known technique for displaying animations of buttons.

FIGS. 31A and 31B are schematic diagrams for explaining another problem in the known technique for displaying animations of buttons.

FIGS. 32A and 32B are schematic diagrams for explaining a further problem in the known technique for displaying animations of buttons.

### DESCRIPTION OF THE PREFERRED EMBODIMENTS

Hereinafter, an embodiment of the invention will be described with reference to drawings. First of all, for easy understanding of the invention, a management structure as prescribed in “Blu-ray Disc Read Only Format Ver. 1.0 part 3 Audio Visual Specification” for contents namely AV (Audio/Video) data prerecorded on a blu-ray disc will be described. In the following description, the management structure in the BD-ROM will be referred to as a BDAV format.

A bit stream that has been encoded in accordance with an encoding system such as MPEG (Moving Pictures Experts Group) video or MPEG audio and multiplexed in accordance with MPEG2 system is referred to as a clip AV stream (or simply an AV stream). The clip AV stream is recorded as a file on a disc by a file system defined in “Blu-ray Disc Read Only Format Ver. 1.0 part 2” for the blu-ray disc. This file is referred to as a clip AV stream file (or simply an AV stream file).

A clip AV stream file is a management unit on the file system. Thus, it cannot be said that the clip AV stream file is a management unit that the user can easily understand. From a view point of user's convenience, it is necessary to record a structure necessary for combining a video content that has been divided into a plurality of clip AV stream files and reproducing the combined video content, a structure necessary for reproducing only a part of a clip AV stream file, information necessary for smoothly performing a special reproduction and a search reproduction, and so forth on a disc as a database. “Blu-ray Disc Read Only Format Ver. 1.0 part 3” as a standard for the blu-ray disc prescribes such a database.

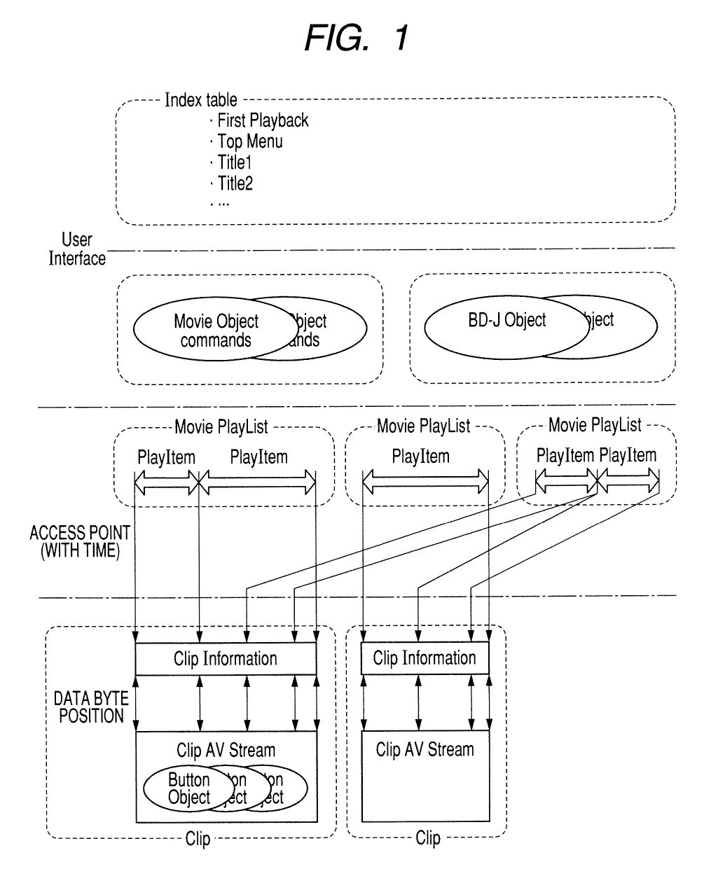

FIG. 1 schematically shows a data model of the BD-ROM. The data structure of the BD-ROM is composed of four layers as shown in FIG. 1. The lowest layer is a layer (referred to as a clip layer for convenience) on which a clip AV stream is placed. Above the clip layer, there is a layer (referred to as a play list layer for convenience) on which a movie play list (Movie PlayList) and a play item (PlayItem) for designating a reproduction position of the clip AV stream are placed. Above the play list layer, there is a layer (referred to as an object layer for convenience) on which a movie object (Movie Object) or the like composed of commands for designating a reproduction order of a movie play list is placed. The highest layer is a layer (referred to as an index layer for convenience) on which an index table for managing a title or the like to be stored in the BD-ROM is placed.

The clip layer will be described. The clip AV stream is a bit stream of which video data and audio data have been multiplexed in the format of an MPEG2 TS (Transport Stream). Information about the clip AV stream is recorded as clip information to a file.

A presentation graphics (PG) stream for displaying a subtitle and an interactive graphics (IG) stream of data used for displaying a menu are also multiplexed into the clip AV stream. The interactive graphics is used as a button image for displaying the menu and is represented as a button object in FIG. 1.

A set of a clip AV stream file and a clip information file that has corresponding clip information is treated as one object and referred to as a clip. A clip is one object that is composed of a clip AV stream and clip information.

A file is generally treated as a sequence of bytes. A content of a clip AV stream file is expanded on the time base. An entry point in the clip is regularly designated on the time base. When a time stamp of an access point to a predetermined clip is given, a clip information file can be used to find information of an address from which data is read in the clip AV stream file.

The play list layer will be described. The play list is composed of information that represents the AV stream file to be reproduced and sets of reproduction start points (IN point) and reproduction stop points (OUT point) that designate a reproduction position of the AV stream file. A pair of information of the reproduction start point and information of the reproduction stop point is referred to as a play item (PlayItem). A movie play list is composed of a set of play items. When a play item is reproduced, a part of the AV stream file which is referred from the play item is reproduced. That is, a corresponding block in the clip is reproduced on the basis of the IN point information and the OUT point information in the play item.

The object layer will be described. The movie object includes a HDMV navigation command program (HDMV program) and terminal information for connecting the movie object. The HDMV program is a command for controlling the reproduction of the play list. The terminal information includes information for allowing a user to interactively operate the BD-ROM player. A user operation such as calling of a menu screen or searching a title is controlled on the basis of the terminal information.

A BD-J object is composed of objects created by a Java® program. Since the BD-J object is not directly related to the invention, the description thereof will be omitted.

The index layer will be described. The index layer is composed of index tables. The index table is a table at a top level for defining a title of the BD-ROM disc. The reproduction of the BD-ROM disc is controlled by a module manager of BD-ROM resident system software on the basis of title information stored in the index table.

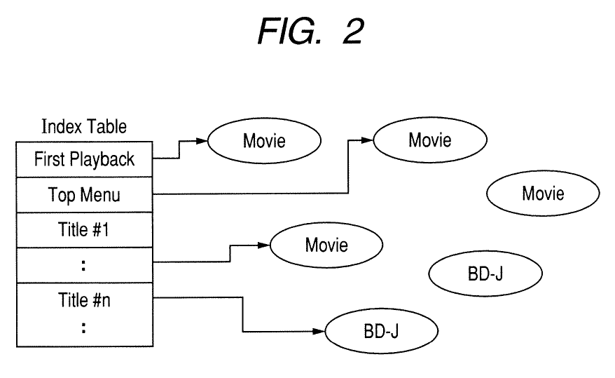

Specifically, as shown in FIG. 2, an entry in the index table is referred to as a title, and a first playback (First Playback), a top menu (Top Menu), and titles (Title) #1, #2, . . . , #n, etc. are titles. Each title represents a link to the movie object or the BD-J object and represents either one of the HDMV title and the BD-J title.

For example, when the contents stored in the BD-ROM is a movie, the first playback is an advertisement picture (trailer) of a movie manufacturing company which is shown prior to a main part of the movie. For example, in the case of movie contents, the top menu is a menu screen for allowing selection of a main part reproduction, a chapter search, a subtitle or language setting, a promotional picture reproduction, or the like. Moreover, the title is a picture selected from the top menu. The title may be configured to have another menu screen.

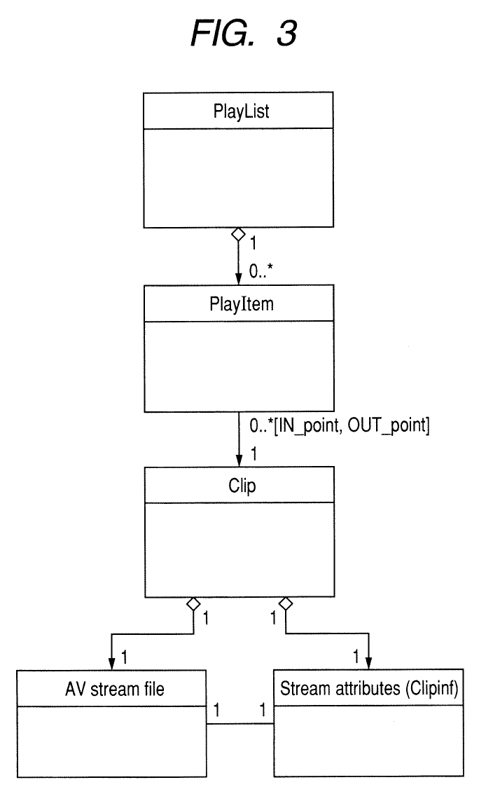

FIG. 3 shows a UML (Unified Modeling Language) diagram that represents the relation of the clip AV stream, clip information (stream attributes), clips, play items, and play list. One play list is correlated with one or a plurality of play items. One play item is correlated with one clip. One clip may be correlated with a plurality of play items whose start points and/or end points are different. One clip AV stream file is referenced from one clip. One clip information file is referenced from one clip. One clip AV stream file and one clip information file are correlated with the relation of one to one. With such a structure defined, a reproduction order can be non-destructively designated by reproducing only any part, not changing a clip AV stream file.

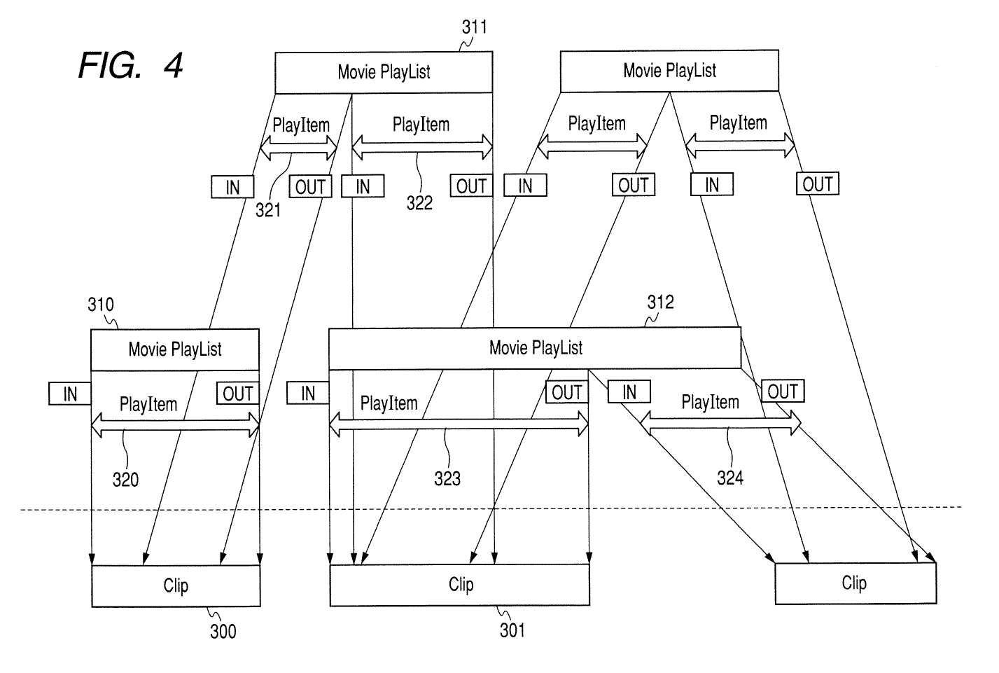

As shown in FIG. 4, the same clip can be referenced from a plurality of play lists. A plurality of clips can be designated from one play list. The clip is referenced by the IN point and the OUT point shown in the play item of the play lists. In the example of FIG. 4, clip 300 is referenced from play item 320 of play list 310, and a block defined by the IN point and the OUT point is referenced from play item 321 of play items 321 and 322 which constitutes play list 311. In addition, in clip 301, a block defined by the IN point and the OUT point is referenced from play item 322 of play list 311, and a block defined by the IN point and the OUT point is referenced from play item 323 of play items 323 and 324 which constitutes play list 312.

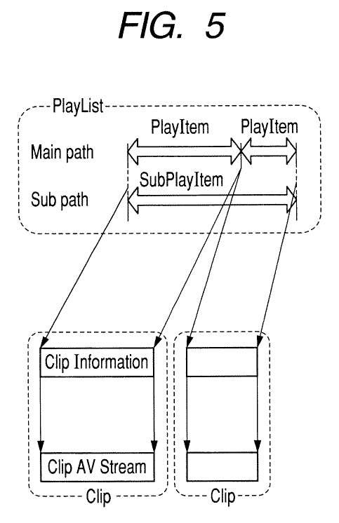

As shown in FIG. 5, the play list may have a sub path corresponding to a sub play item in addition to a main path corresponding to a main play item which is mainly reproduced. The sub play item is a play item for after recording audio added to the play list. Although not shown in drawing, a play list can have a sub play item only when the play list satisfies a predetermined condition.

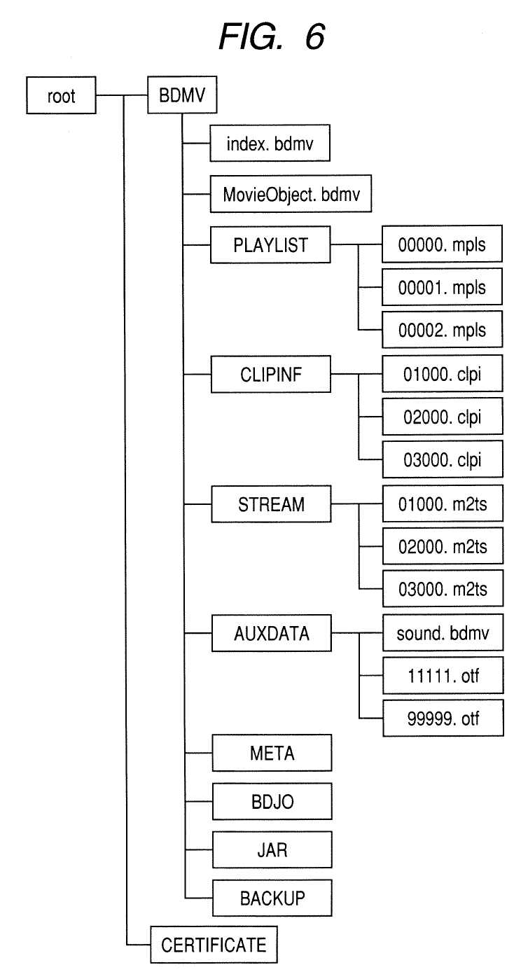

Next, with reference to FIG. 6, a management structure for files recorded on the BD-ROM prescribed in “Blu-ray Disc Read Only Format part 3” will be described. Files are hierarchically managed in a directory structure. First, one directory (a root directory in the example shown in FIG. 6) is created on the recording medium. Under the directory, files are managed by one recording and reproducing system.

Under the root directory, directories “BDMV” and “CERTIFICATE” are placed. Copyright information is stored in the directory “CERTIFICATE”. The data structure described with relation to FIG. 1 is stored in the directory “BDMV”.

Right under the directory “BDMV”, only files “index.bdmv” and “Movieobject.bdmv” can be placed. Under the directory “BDMV”, directories “PLAYLIST”, “CLIPINF”, “STREAM”, “AUXDATA”, “META”, “BDJO”, “JAR”, and “BACKUP” are placed.

Content of the directory BDMV is described in the file “index.bdmv”. That is, the file “index.bdmv” corresponds to the index table in the index layer which is the highest layer described above. In addition, one or more information about the movie object is stored in the file “MovieObject.bdmv”. That is, the file “Movieobject.bdmv” corresponds to the object layer described above.

A directory “PLAYLIST” is a directory on which a database of the play lists is placed. That is, the directory “PLAYLIST” includes a file “xxxxx.mpls” which is related to the movie play list. The file “xxxxx.mpls” is created for each of the movie play lists. Regarding file names, “xxxxx” appearing before “.” (period) is composed of five digit number and “mpls” appearing after the period represents an extension which is fixed for this file type.

A database of the clip is placed on a directory “CLIPINF”. That is, the directory “CLIPINF” includes a file “zzzzz.clpi” which represents information about the clips for each of the clip AV stream. Regarding file names, “zzzzz” appearing before the period is composed of five digit number and “clpi” appearing after the period represents an extension which is fixed for this file type.

An AV stream file serving as an entity is placed on a directory “STREAM”. That is, the directory “STREAM” includes clip AV stream files corresponding to the clip information files. The clip AV stream files are composed of an MPEG2 transport stream (hereinafter, referred to as MPEG2 TS) and have “zzzzz.m2ts” as file names thereof. Regarding file names, “zzzzz” appearing before the period is the same as that of corresponding clip information file. Thus, it is possible to easily understand correspondence between the clip information file and the clip AV stream file.

Files such as a sound file, a font file, a font index file, a bit map file, or the like used in a menu display are placed on a directory “AUXDATA”. Sound data related to interactive graphics stream applications of the HDMV is stored in a file “sound.bdmv”. The file name of the sound data is fixed as “sound.bdmv”. Font data used in a subtitle display or the BD-J application described above is stored in a file “aaaaa.otf”. Regarding file names, “aaaaa” appearing before the period is composed of five digit number and “otf” appearing after the period represents an extension which is fixed for this file type. A file “bdmv.fontindex” is an index file of fonts.

Meta data files are stored in the directory “META”. Files related to the BD-J object described above are stored in directories “BDJO” and “JAR”. Backups for the directories and files described above are stored in the directory “BACKUP”. Since these directories “META”, “BDJO”, “JAR”, and “BACKUP” are not directly related to the subject matter of the invention, the description thereof will be omitted.

When a disc having the above-mentioned data structure is loaded to a player, the player needs to convert commands described in the movie objects which are read out from the disc into a unique command for controlling hardware installed in the player. In the player, software for performing the conversion is already stored in a ROM (Read Only Memory) which is built in the player. The software interfaces between the disc and the player so as to allow the player to perform operations in accordance with the BD-ROM specification and thus is referred to as a BD virtual player.

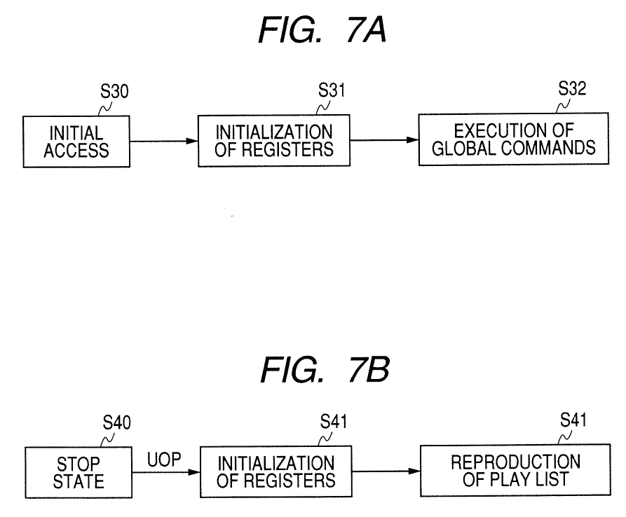

FIGS. 7A and 7B show an outlined operation of the BD virtual player. FIG. 7A shows an example of a disc loading operation. When the disc is loaded into the player and then an initial access is performed to the disc (step S30), registers to which common parameters commonly used in the disc are stored are initialized (step S31). In the next step S32, a program is read from the disc and executed. The initial access represents an operation of which reproduction of a disc is first performed, for example, when the disc is loaded into the player.

FIG. 7B shows an example of an operation of the player when the user presses for example a play key while the player is in a stop state. In the first stop state (step S40), the user instructs to perform a reproduction operation by using, for example, a remote controller (UO: User Operation). When the reproduction operation is instructed, the registers (namely, the common parameters) are initialized (step S41). In the next step S42, the player enters a play list reproduction phase. In this case, the registers may be implemented such that the registers are not reset.

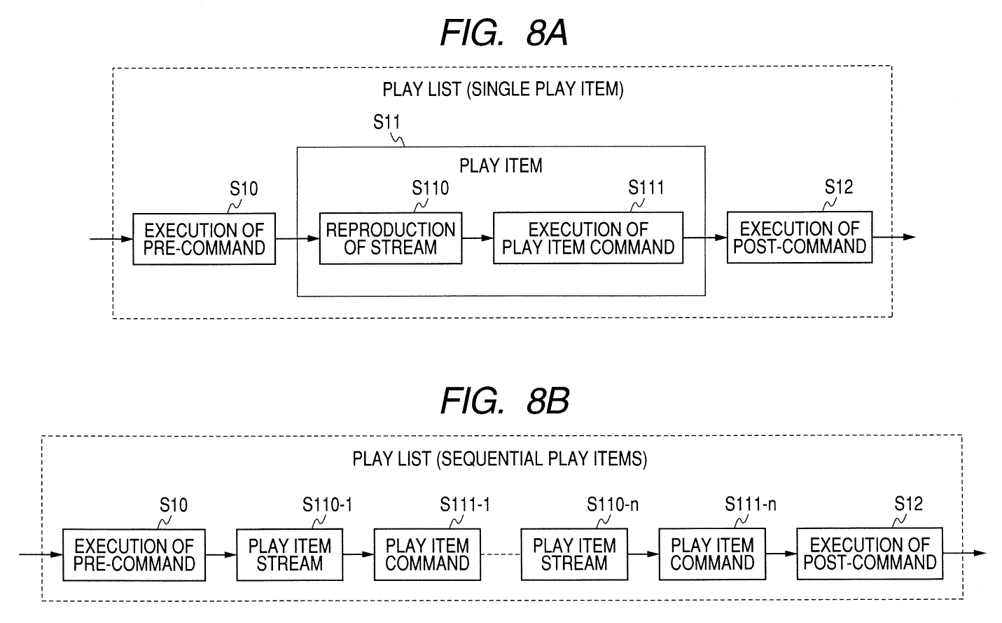

Next, with reference to FIGS. 8A and 8B, reproduction of a play list in the play list reproduction phase will be described. FIG. 8A shows an example of which a play list is composed of a single play item. The play list has a pre-command region, a play item command region, and a post-command region on which respective programs are arranged. In the play list reproduction phase, a pre-command of the pre-command region is executed (step S10). After the pre-command has been executed, the player enters a play item reproduction phase for play items that compose the play list (step S11). In the play item reproduction phase, a stream whose start point and end point are designated by the play item is reproduced (step S110). When the stream has been reproduced up to the end point, the play item command is executed (step S111). After the play item command has been executed, a post command of the post-command region is executed (step S12). As a result, the reproduction of the play list is completed.

The post command is normally described with a jump command for a play list to be reproduced next or a play list that composes a menu screen. When there is no a jump command, the reproduction is stopped at that point and the player enters the stop state.

FIG. 8B shows an example of which a play list includes a plurality of play items. Even in this case, the play list has a pre-command region, a play item command region, and a post-command region where respective programs are arranged and stored. When the play list includes a plurality of play items, play item streams and play item commands of play items are arranged in a time sequence on the play item command region.

Even when the play list includes a plurality of play items, in the play list reproduction phase, a pre-command is executed (step S10). In the next play item reproduction phase, a stream is reproduced from the start point to the end point of each play item and a play item command is executed for the number of play items contained in the play list. In the example shown in FIG. 8B, a first play item stream is reproduced (step S110-1). Thereafter, the corresponding play item command is executed (step S111-1). Thereafter, although not shown in drawing, a second play item stream (not shown) is reproduced (step S110-2). The corresponding play item command is executed (step S111-2). These operations are repeated for the number of the play items. After the last play item stream has been reproduced (step S110-n) and the corresponding play item command has been executed (step S111-n), the play item reproduction phase is completed. After the play item reproduction phase has been completed, a post command is executed (step S12). As a result, the play list reproduction phase is completed.

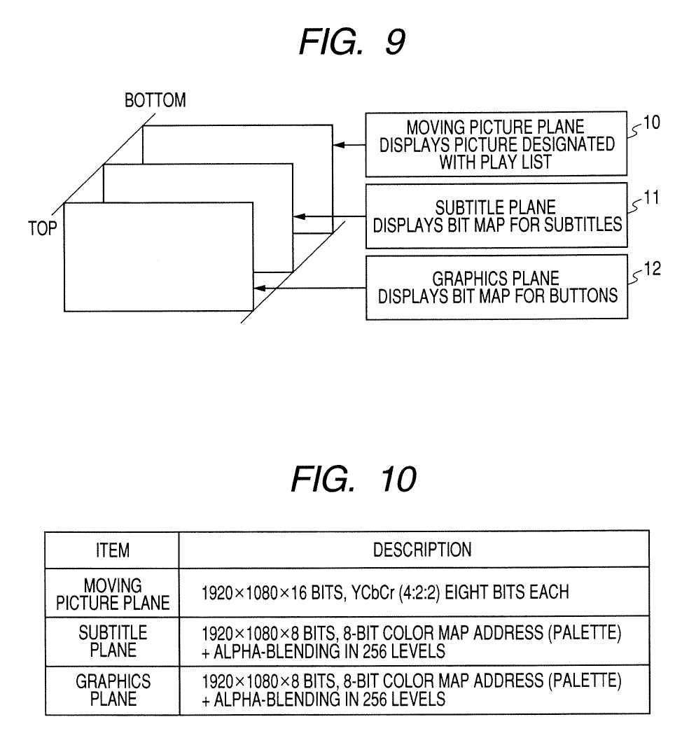

Next, a display system of a picture which is applicable to the embodiment of the invention will be described. According to the embodiment of the invention, a plane structure as shown in FIG. 9 is used as the display system of the picture. A moving picture plane 10 is displayed on the rearmost side (bottom). The moving picture plane 10 deals with a picture (mainly, moving picture data) designated by the play list. A subtitle plane 11 is displayed above the moving picture plane 10. The subtitle plane 11 deals with subtitle data displayed while the moving picture is being reproduced. A graphics plane 12 is displayed on the front-most side. The graphics plane 12 deals with character data for displaying a menu screen and graphics data such as bit map data for displaying button images. One display screen is composed of these three planes.

The moving picture plane 10, the subtitle plane 11, and the graphics plane 12 can be independently displayed and have resolutions and display colors as shown in FIG. 10. The moving picture plane 10 has a resolution of 1920 pixels*1080 lines, a data length of 16 bits per pixel, a color system of YCbCr (4:2:2), where Y represents a luminance signal and Cb and Cr represent color difference signals. YCbCr (4:2:2) is a color system having a luminance signal Y of eight bits per pixel and color difference signals Cb and Cr of eight bits each. With two horizontal pixels of the color difference signals Cb and Cr, data of one color data is composed. The graphics plane 12 and the subtitle plane 11 have a resolution of 1920 pixels*1080 lines, a sampling depth of eight bits per pixel, and a color system having eight-bit color map addresses using a palette of 256 colors.

The graphics plane 12 and the subtitle plane 11 can be alpha-blended in 256 levels. When the graphics plane 12 and the subtitle plane 11 are combined with another plane, the transparency can be set in 256 levels. The transparency can be set for each pixel. In the following description, the transparency α is represented in the range of (0≦α≦1) where transparency α=0 represents perfect transparent; transparency α=1 represents perfect opaque.

The subtitle plane 11 deals with picture data of for example PNG (Portable Network Graphics) format. Similarly, the graphics plane 12 can deal with picture data of the PNG format. In the PNG format, the sampling depth of one pixel is in the range from one bit to 16 bits. When the sampling depth is 8 bits or 16 bits, an alpha channel, namely transparency information (referred to as alpha data) of each pixel component can be added. When the sampling depth is eight bits, transparency can be designated in 256 levels. With the transparency information of the alpha channel, alpha-blending is performed. A palette image of up to 256 colors can be used. An element (index) of the prepared palette can be represented with an index number.

Picture data dealt with the subtitle plane 11 and the graphics plane 12 is not limited to the PNG format. Alternatively, picture data that has been compression-encoded in accordance with for example JPEG system, picture data that has been run-length-compressed, or bit map data that has not been compression-encoded may be used.

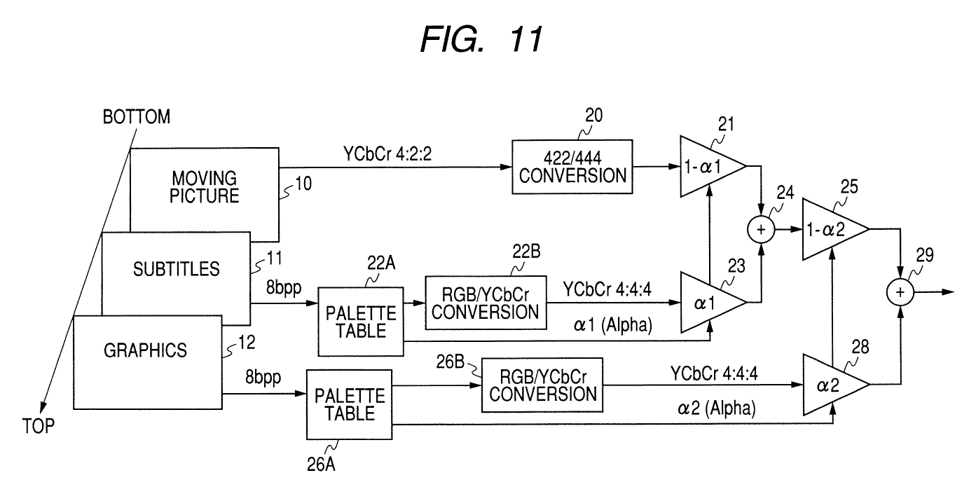

FIG. 11 shows an exemplary structure of a graphics processor which combines three planes in accordance with the examples shown in FIG. 9 and FIG. 10. Moving picture data of the moving picture plane 10 is supplied to a 422/444 converting circuit 20. The 422/444 converting circuit 20 converts the color system of the moving picture data from YCbCr (4:2:2) into YCbCr (4:4:4) and inputs the converted data to a multiplying device 21.

Picture data of the subtitle plane 11 is input to a palette 22A. The palette 22A outputs picture data of RGB (4:4:4). When transparency of alpha-blending is designated for the picture data, designated transparency α1 (0≦α1≦1) is output from the palette 22A.

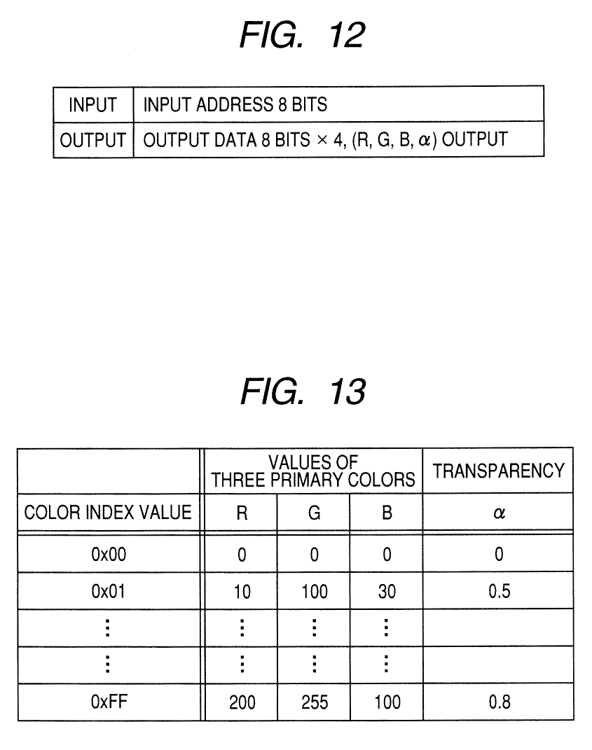

FIG. 12 shows an example of input/output data of the palette 22A. The palette 22A stores palette information as a table corresponding to, for example, a PNG format file. An index number is referenced as an address of picture data of eight-bit input data from the palette 22A. The data of RGB (4:4:4) composed of data of eight bits each is output in accordance with the index number. In addition, data α of the alpha-channel that represents transparency is obtained from the palette 22A.

FIG. 13 shows an exemplary palette table stored in the palette 22A. 256 color index values [0x00] to [0xFF] (where [0x] represents hexadecimal notation) are assigned three primary color values R, G, and B each of which is represented with eight bits, and transparency α. The palette 22A references the palette table in accordance with the input PNG format picture data and outputs data of colors R, G, and B (RGB data), each of which is represented with eight bits, and transparency α, corresponding to the index value designated by the picture data.

The RGB data that is output from the palette 22A is supplied to an RGB/YCbCr converting circuit 22B. The RGB/YCbCr converting circuit 22B converts the RGB data into a luminance signal Y and color difference signals Cb and Cr of eight bits each (hereinafter, collectively referred to as YCbCr data). This is because data of planes should be combined in the common data format. Therefore, data is unified to YCbCr data that is a data format of the moving picture data.

The YCbCr data and the transparency data α1 that are output from the RGB/YCbCr converting circuit 22B are input to a multiplying device 23. The multiplying device 23 multiplies the input YCbCr data by the transparency data α1. The multiplication result is input to one input terminal of an adding device 24. The multiplying device 23 multiplies each of the luminance signal Y and the color difference signals Cb and Cr of the YCbCr data by the transparency data α1. A complement (1-α1) of the transparency data α1 is supplied to the multiplying device 21.

The multiplying device 21 multiplies the moving picture data that is input from the 422/444 converting circuit 20 by the complement (1-α1) of the transparency data α1. The multiplication result is input to the other input terminal of the adding device 24. The adding device 24 adds the multiplication results of the multiplying device 21 and the multiplying device 23. As a result, the moving picture plane 10 and the subtitle plane 11 are combined. The addition result of the adding device 24 is input to a multiplying device 25.

Picture data of the graphics plane 12 is input to the palette table 26A and output as input a picture data of RGB (4:4:4). When transparency of alpha-blending has been designated to the picture data, the designated transparency α2 (0≦α2≦1) is output from the palette 26A. The RGB data output from the palette 26A is supplied to RGB/YCbCr converting circuit 26B and the RGB data is converted into YCbCr data and unified to YCbCr data that is a data format of the moving picture data. The YCbCr data output from the RGB/YCbCr converting circuit 26B is input to the multiplying device 27.

When the picture data used in the graphics plane 12 is described in the PNG format, it is possible to set transparency data of each pixel in the picture data to α2 (0≦α2≦1). The transparency data α2 is supplied to the multiplying device 27. The multiplying device 27 multiplies each of the luminance signal Y and the color difference signals Cb and Cr of the YCbCr data that is input from the RGB/YCbCr converting circuit 26 by the transparency data α2. The multiplication result of the multiplying device 27 is input to one input terminal of an adding device 28. A complement (1-α2) of the transparency data α2 is supplied to the multiplying device 25.

The multiplying device 25 multiplies the addition result of the adding device 24 by the complement (1-α2) of the transparency data α2. The multiplication result of the multiplying device 25 is input to the other input terminal of the adding device 28 and added to the multiplication results of the multiplying device 27. As a result, the graphics plane 12 is combined with the combined result of the moving picture plane 10 and the subtitle plane 11.

When the transparency a of a non-picture region of the subtitle plane 11 and the graphics plane 12 is designated to 0 (α=0), a plane below those planes 11 and 12 becomes transparent. As a result, the moving picture data displayed on the moving picture plane 10 can be displayed as a background of the subtitle plane 11 and the graphics plane 12.

The structure shown in FIG. 11 can be accomplished by hardware or software.

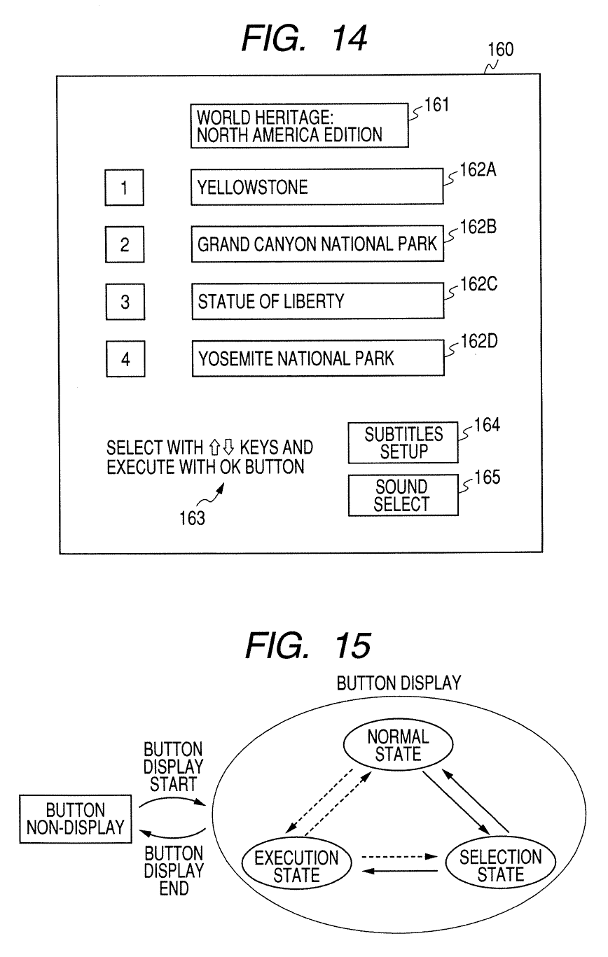

A screen that prompts the user to perform an operation, for example, a menu screen, can be displayed on the graphics plane 12. FIG. 14 shows an exemplary menu screen 160 displayed on the graphics plane 12. On the menu screen 160, characters and images are displayed at particular positions. With the characters and images, “buttons” that allow the user to select to new operations can be placed on the menu screen 160. The menu screen 160 can provide a GUI (Graphical User Interface) to the user.

The “button” is an image to which a predetermined function of a program is assigned. When the button image is designated by the user, the function assigned to the button is activated. That is, the “button” on the GUI is an element on the GUI that changes a device state by executing the function of the program in accordance with a user operation. The “button” has three types of image data that represent a normal state, a selected state, and a pressed state (or an execution designation state). When the user designates the button image, the screen display is generally changed between the three types of image data. With such arrangement of the “button”, the user can easily recognize his or her operation and it is thus desirable. In addition, animations for each of the three types of image data used in the “button” may be defined.

The designation operation of the “button” may be performed with, for example, a key operation of the remote controller. For example, the user may operate a predetermined key such as a direction key capable of designating up, down, left, and right directions so as to select one “button” that he or she desires to designate, thereby designating the selected “button” with an OK key or the like. Alternatively, the designation operation of the “button” may be performed by moving a cursor on the screen with a pointing device such as a mouse and clicking a mouse button (pressing the mouse button several times) on the image of the “button”. The same operation can be performed with another pointing device other than the mouse.

In the example shown in FIG. 14, a title 161 as image data is displayed at an upper portion of the menu screen 160 that is displayed on the graphics plane 12. The title 161 is followed by buttons 162A, 162B, 162C, and 162D. When the user selects and designates one of the buttons 162A, 162B, 162C, and 162D with a key operation of, for example, the remote controller, a function assigned to the designated button is activated.

At lower positions of the menu screen 160, buttons 164 and 165 are displayed. With the buttons 164 and 165, subtitles can be displayed and a language of output sound can be selected from, for example, English and Japanese. When the buttons 164 and 165 are operated in the foregoing manner, functions for displaying their setup screens are activated and the predetermined screens are displayed.

At a lower left portion of the menu screen 160, a character string 163 that describes a method of selecting an item is displayed. The character string 163 is displayed on the graphics plane 12.

FIG. 15 is a schematic diagram showing an example of state change of a button displayed on the graphics plane 12. The button display state mainly includes a button display state in which a button is displayed on the screen and a button non-display state in which a button is not displayed on the screen. The button non-display state is changed to the button display state. After the button display is cleared, the button display state is changed to the button non-display state. The button display state has further three states that are a normal state, a selected state, and an activated state. The button display state can be changed among the three states. The button display state may be changed in one direction among the three states. In addition, respective animations of the three button display states may have defined.

Next, with reference to FIG. 14, the state changes of the button display states will be described in detail. When a disc is loaded into the player or when the user presses the menu key of the remote controller, the menu screen 160 is displayed. When the menu screen 160 is displayed, the button display states of the buttons 162A, 162B, 162C, 162D, 164, and 165 are changed from the non-display states to the display states. Normally, one of the buttons 162A, 162B, 162C, 162D, 164, and 165 is placed in the selected state. Now, it is assumed that the button 162A is placed in the selected state and the other buttons are placed in the normal state.

When the user operates for example an arrow key of the remote controller, one (for example, the button 162B) of the buttons is changed from the normal state to the selected state. In addition, the button 162A is changed from the selected state to the normal state. The cursor is moved in accordance with the user operation. When the user operates the OK key of the remote controller, the button 162B is changed from the selected state to the activated state. As a result, a player operation assigned in advance to the button 162B is activated.

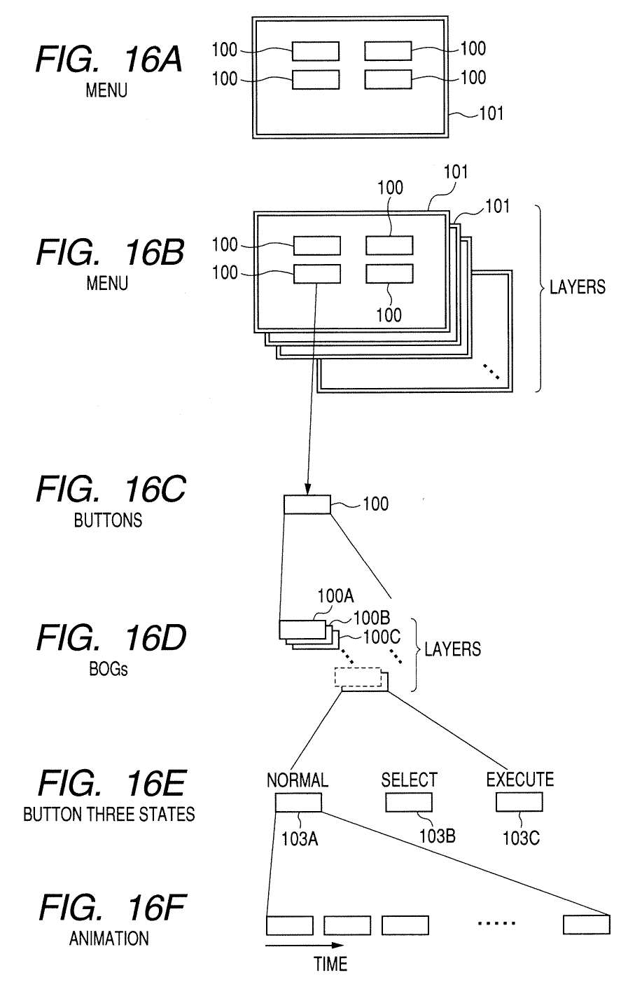

Next, the menu screen that is applied to an embodiment of the invention will be described with attention to the button images. FIGS. 16A to 16F schematically show arrangements of the menu screen and the buttons. The menu screen 101 on which a plurality of buttons 100 are arranged as shown in FIG. 16A will be considered.

The menu screen 101 may have a structure in which a plurality of menu screens are hierarchically arranged as shown in FIG. 16B. For example, an arrangement may be considered in which a button 100 on a menu screen located at a front-most side is changed from the selected state to the activated state by a predetermined input unit, whereby a menu screen right under the front-most side menu screen becomes a new front-most side menu screen. In the following description, “changing the state of the button by the predetermined input unit” will be expressed simply by “operating the button” for convenience of the expression.

One button 100 displayed on the menu screen 101 may have a structure in which a plurality of buttons 100A, 100B, . . . , or the like are hierarchically arranged (see FIGS. 16C and 16D for reference). In other words, it means that a plurality of buttons are selectively displayed at the position of the one button. For example, when a predetermined button among the plurality of buttons is operated to change functions and display of several other buttons that are displayed at the same time, it is unnecessary to rewrite the menu screen itself and it is thus suitable for use. A set of buttons which is selectively displayed at a position corresponding to one button is referred to as BOGs (Button Overlap Group).

Each button that constitutes the BOGs may have the above-mentioned three states. That is, as shown in FIG. 16E, each button that constitutes the BOGs may have buttons 103A to 103C each of which represents the normal state, the selected state, and the activated state, respectively. In addition, animations may be designated for each of the buttons 103A to 103C for displaying the three states, as shown in FIG. 16F. In this case, the button for which the animation is designated is composed of a plurality of button images corresponding to the number of images used for displaying the animation.

Each of the plurality of button images constituting the animations of the button will be hereinafter referred to as an animation frame.

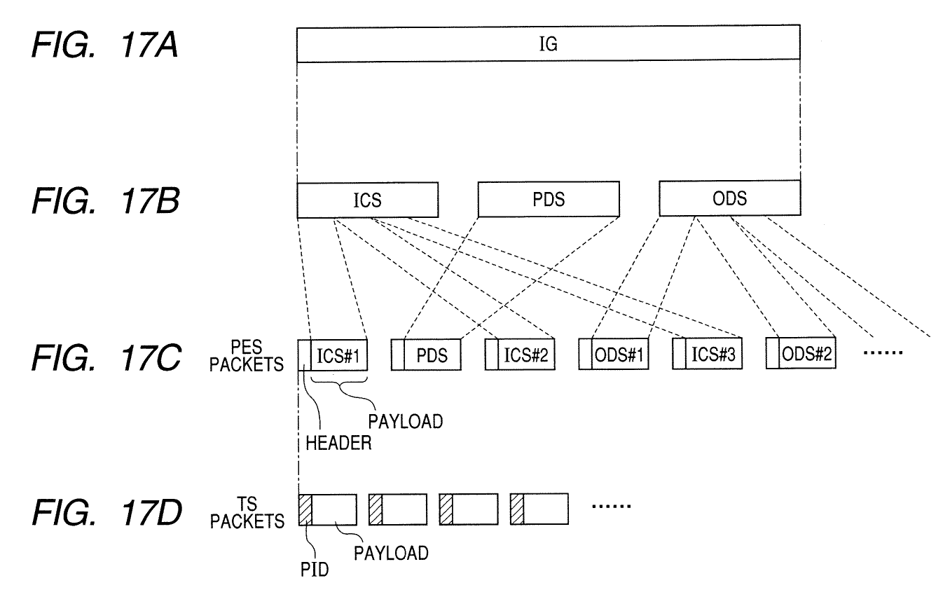

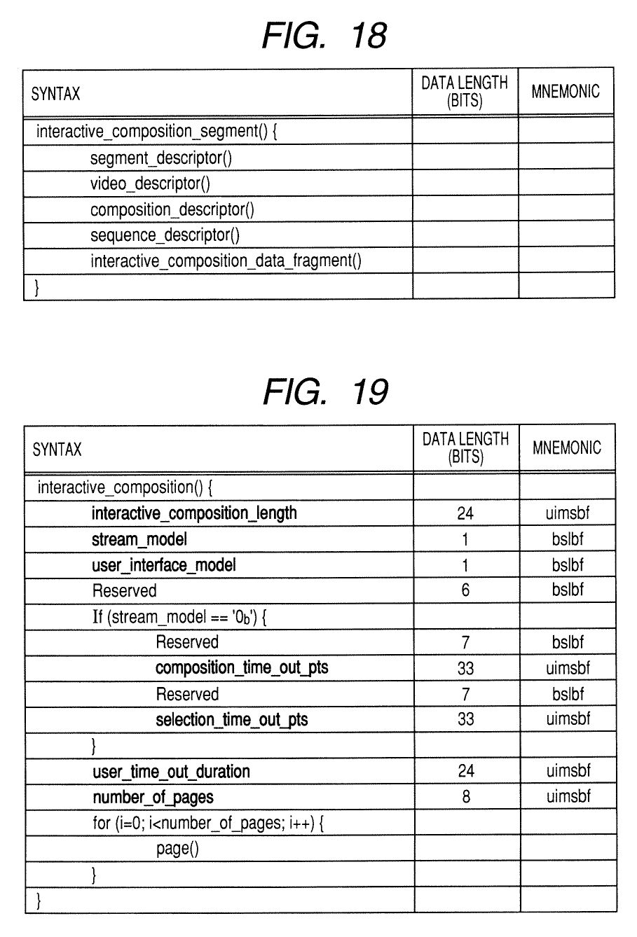

Next, an example of storage format of the button images having the above-mentioned structure will be described with reference to FIGS. 17A to 17D. As described above, the button images are an interactive graphics (IG) stream (see FIG. 17A for reference) and are multiplexed into a clip AV stream. As shown in FIG. 17B, the interactive graphics stream includes three types of function segments, namely, an ICS (Interactive Composition Segment), a PDS (Palette Definition Segment), and an ODS (Object Definition Segment).

Among the three types of segments, the ICS is a segment for maintaining a basic structure of the IG, details of which are described later. The PDS is a segment for maintaining color information of the button images. The ODS is a segment for maintaining a shape of the button. More specifically, the button images themselves, for example, bit map data for displaying the button images is compressed and encoded by a predetermined compression encoded method such as run-length compression and stored in the ODS.

As shown in FIG. 17C, these segments ICS, PDS, and ODS are divided in a predetermined manner as required, differentiated by a PID (Packet Identification), and stored in a payload of a PES (Packetized Elementary Stream) packet. Since the size of PES packet is fixed to 64 KB (Kilo byte), the ICS and ODS having a relatively huge size are divided in a predetermined manner and contained in the payload of the PES packet. Meanwhile, since the size of PDS is smaller than 64 KB in many cases, the PDS corresponding to one IG can be stored in one PES packet. In each PES packet, information representing that data stored in the payload belongs to which segment of the ICS, PDS, and ODS and identification information representing the order of the packets are stored in the PID.

Each PES packet is divided in a predetermined manner and contained in an MPEG TS transport packet (FIG. 17D). The order of the transport packets and identification information for identifying data stored in the transport packets are stored in the PID.

In an embodiment of the invention, a predetermined flag is provided to the ICS so as to suitably control the animation display of the button images. The structure of the ICS according to an embodiment of the invention will be described with reference to FIGS. 18 to 22.

FIG. 18 shows syntax that describes an exemplary structure of header information of the ICS. The syntax is represented by a descriptive method of C language, which is used as a program descriptive language for computer devices. This applies to drawings that show other syntaxes.

The header of the ICS is configured to include a block segment_descriptor( ), a block video_descriptor( ), a block composition_descriptor( ), a block sequence_descriptor( ), and a block interactive_composition_data_fragment ( ). The block segment_descriptor( ) describes that the segment is the ICS. The block video_descriptor( ) describes a frame rate and a picture frame size of videos that are displayed concurrently with the menu. The block composition_descriptor( ) describes a state of the ICS. The block sequence_descriptor( ) describes whether the ICS extends over a plurality of PES packets.

More specifically, the block sequence_descriptor( ) describes whether the ICS contained in the current PES packet is a beginning side or an ending side of one IG stream.

In other words, as described above, when the data size of the ICS is greater than that of the PES packet having a fixed data size fixed to 64 KB, the ICS is divided in a predetermined manner and contained in the PES packets. In this case, the header portion shown in FIG. 18 needs only to be contained in the first and the last PES packets of the entire PES packets in which the divided ICSs are contained. The header portion may not be contained in other PES packets. When the block sequence_descriptor ( ) describes the beginning one and the last one, it can be seen that the ICS is contained in one PES packet.

FIG. 19 shows syntax that describes an exemplary structure of a block interactive_composition_data_fragment ( ). In FIG. 19, the block is represented as a block interactive_composition( ). A field interactive_composition_length has a data length of 24 bits and represents a data length of the block interactive_composition( ) after the field interactive_composition_length. A field stream_model has a data length of 1 bit and represents whether the stream is multiplexed or not. That is, the interactive graphics stream may be multiplexed with respect to the AV stream or may solely constitute the clip AV stream.

A field user_interface_model has a data length of 1 bit and represents whether a menu displayed by the stream is a popup menu or a normal menu that is always displayed on a menu screen. The popup menu is a menu that appears or disappears by a predetermined input unit, namely, ON or OFF button of the remote controller, for example. Meanwhile, the normal menu may not disappear by the user operation. When the value of the field user_interface_model is “0”, it describes the popup menu. When the value of the field user_interface_model is “1”, it describes the normal menu.

When the value of the field user_interface_model is “0” a field composition_time_out_pts and a field selection_time out_pts that are described after an IF statement, namely, If(stream_model==‘0_{b}’) become valid. The field composition_time_out_pts has a data length of 33 bits and represents a time when the menu is disappeared. The field selection_time_out_pts has a data length of 33 bits and represents a time when a selection operation becomes unavailable in the menu display. The time is described in pts (Presentation Time Stamp) that is prescribed in MPEG2.

A field user_time_out_duration has a data length of 24 bits and represents an auto-initialization time of the menu display. The next field number_of_pages has a data length of 8 bits and represents the number of menu pages with an initial value of 0. That is, when the menu display has a hierarchical structure described with relation to FIG. 16B and has a plurality of pages, the value of the field number_of_pages is 1 or more. A loop beginning at the next for statement is repeatedly performed by the number of times described in the field number_of_pages. In this case, each page for displaying is defined for each of the menus.

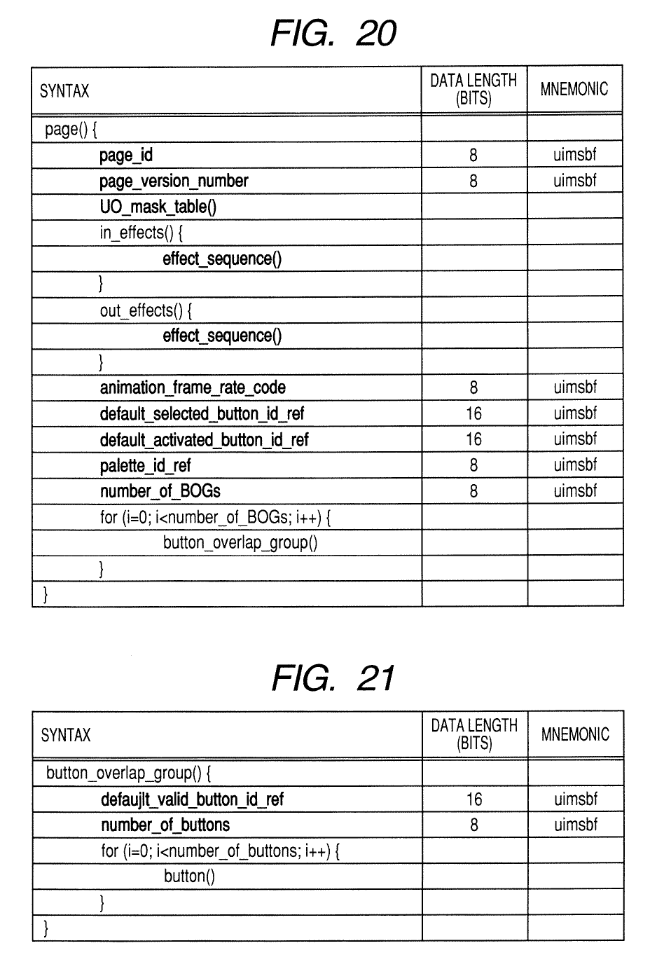

FIG. 20 shows syntax that describes an exemplary structure of the block page( ). A field page_id has a data length of 8 bits and represents ID for identifying pages. A field page_version_number has a data length of 8 bits and represents a version number of the page. The next block UO_mask_table( ) represents a table in which a user operation on the input unit that is prohibited in the process of displaying the page is described.

A block in_effect ( ) is a block representing an animation displayed when the page is displayed. A block effect_sequence( ) described in braces { } describes a sequence of the animation. A block out_effect ( ) is a block representing an animation displayed when the page is ended. A block effect_sequence ( ) described in braces { } describes a sequence of the animation. The block in_effect( ) and the block out_effect( ) are animations that are activated when the ICS is found in the pages after the movement, which are different from the animations of the button images related to the invention.

A field animation_frame_rate_code has a data length of 8 bits and represents a setting parameter of the frame rate of the animation when the button images of the page are displayed with animations. For example, when the frame rate of video data in the clip AV stream file correlated with the ICS is V_{frm} and the frame rate of the animation is A_{frm}, the value of the field animation_frame_rate_code may be represented by a ratio between these frame rates, namely, V_{frm}/A_{frm}.

A field default_selected_button_id_ref has a data length of 16 bits and represents an ID for designating a button that is first changed to the selected state when the page is displayed. The next field default_activated_button_id_ref has a data length of 16 bits and represents an ID for designating a button that is automatically changed to the activated state when it is reached to the time represented by the field selection_time_out_pts described with relation to FIG. 19.

A field palette_id_ref has a data length of 8 bits and represents an ID of a palette referenced by the page. That is, the color information of the PDS in the IG stream is designated by the field palette_id_ref.

The next field number_of_BOGs has a data length of 8 bits and represents the number of BOGs used in the page. A loop beginning at the next for statement is repeatedly performed by the number of times described in the field number_of_BOGs. In this case, each of the BOGs is defined by the block button_overlap group( ).

FIG. 21 shows syntax that describes an exemplary structure of a block button_overlap_group( ). A field default_valid_button_id_ref has a data length of 16 bits and represents an ID of a button that is first displayed in the BOGs defined by the block button_overlap_group( ). The next field number_of_buttons has a data length of 8 bits and represents the number of buttons used in the BOGs. A loop beginning at the next for statement is repeatedly performed by the number of times described in the field number_of_buttons. In this case, each of the buttons is defined by the block button( ).

In other words, as described above, the BOGs may have a plurality of buttons and each structure of the plurality of buttons is defined by the block button( ). The button structure defined by the block button( ) is actually displayed as a button.

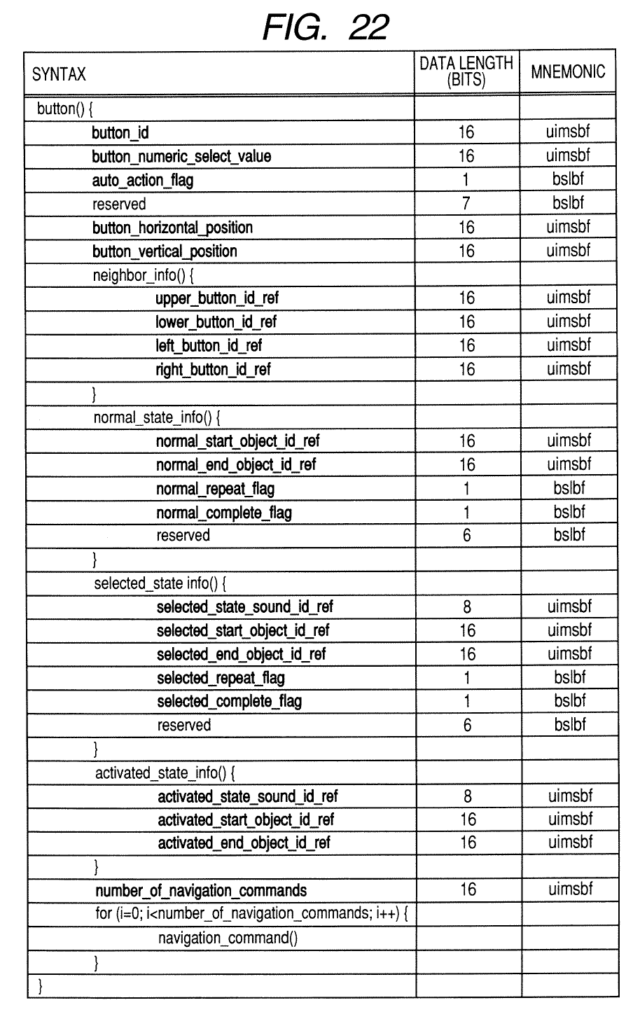

FIG. 22 shows syntax that describes an exemplary structure of a block button( ). A field button_id has a data length of 16 bits and represents an ID for identifying the button. A field button_numeric_select_value has a data length of 16 bits and represents that the button is assigned to which number of number keys on the remote controller. A flag auto_action_flag has a data length of 1 bit and represents whether a function assigned to the button is automatically activated or not when the button is changed to the selected state.

The next fields, namely, button_horizontal_position and button_vertical_position have a data length of 16 bits, respectively, and represent positions in horizontal and vertical directions on a screen on which the button is displayed, respectively.

A block neighbor_info( ) represents information about neighborhood of the button. That is, the value described in the block neighbor_info( ) represents which one of neighboring buttons is changed to the selected state when the user operates the direction key capable of designating up, down, left, and right directions on the remote controller in a state that the button is in the selected state. Among fields in the block neighbor_info( ), a field upper_button_id_ref, a field lower_button_id_ref, a field left_button_id_ref, and a field right_button_id_ref have a data length of 16 bits, respectively, and represent an ID of a button which is changed to the selected state when the user has designated the up, down, left, and right directions, respectively.

The next blocks, namely, a block normal_state_info( ), a block selected_state_info( ), and a block activated_state_info( ) represent information of a button in the normal state, in the selected state, and the activated state, respectively. Among these blocks, a flag related to the embodiment of the invention is applied to the block normal_state_info( ) and the block selected_state_info( ).

First, the block normal_state_info( ) will be described. A field normal_start_object_id_ref and a field normal_end_object_id_ref have a data length of 16 bits, respectively, and represent an ID for designating the first and last objects of the animations of a button in the normal state. That is, with these fields, namely, the field normal_start_object_id_ref and the field normal_end_object_id_ref, the button images (namely, an animation frame) used for displaying the buttons are designated to the corresponding ODS.

The next flag normal_repeat_flag has a data length of 1 bit and represents whether the animation of the button is repeated. For example, when the value of the flag normal_repeat_flag is “0”, the animation of the button is not repeated. When the value of the flag normal_repeat_flag is “1”, the animation of the button is repeated.

The next flag normal_complete_flag has a data length of 1 bit and this flag is defined in the invention. The flag normal_complete_flag is a flag for controlling the movement of the animations when the button is changed from the normal state to the selected state.

That is, when the value of the normal_complete_flag is “1”, the entire animations for the button defined as the normal state are displayed when the button is changed from the normal state to the selected state. More specifically, in a case where the value of the normal_complete_flag is “1” and it is instructed to change the state of the button from the normal state to the selected state in the process of displaying a normal state animation of the button, animations are displayed from the animation frame that is displayed at that moment up to the animation frame that is described in the field normal_end_object_id_ref.

Similarly, when the value of the flag normal_complete_flag is “1” and the flag normal_repeat_flag describes to repeat the animations (for example, the value of “1”), animations are displayed from the animation frame that is displayed at that moment up to the animation frame that is described in the field normal_end_object_id_ref.

In this case, even in a case where it is unable to select the button or the button display is disappeared, when the changing of these states occurs in the process of displaying the animations, the animations are displayed up to the animation frame that is described in the field normal_end_object_id_ref, and thereafter the state of the button is changed.

As a state where it is unable to select the button, for example, a case where selection of the button becomes unavailable due to the designation in the field selection_time_out_pts or a case where the menu is automatically initialized by the designation in the field user_time_out_duration may be considered.

Meanwhile, in a case where the value of the flag normal_complete_flag is “0”, the animation display is stopped at a time being instructed to change the state of the button and the button in the selected state is displayed on the screen, rather than displaying the animations for the buttons defined as the normal state up to the animation frame that is described in the field normal_end_object_id_ref when the button is changed from the normal state to the selected state.

Next, the block selected_state info( ) will be described. In the block selected_state_info( ), a field selected_state_sound_id_ref for designating a sound is added to the block normal_state_info( ) described above. The field selected_state_sound_id_ref has a data length of 8 bits and represents a sound file that is reproduced with the button in the selected state. For example, the sound file is used as an effect sound when the button is changed from the normal state to the selected state.

A field selected_start_object_id_ref and a field selected_end_object_id_ref have a data length of 16 bits, respectively, and represent an ID for designating the first and last objects of the animations of the buttons in the selected state, respectively. The next flag selected_repeat_flag has a data length of 1 bit and represents whether the animation of the button is repeated. For example, when the value of the flag selected_repeat_flag is “0”, the animation of the button is not repeated. When the value of the flag selected_repeat_flag is “1”, the animation of the button is repeated.

The next flag selected_complete_flag has a data length of 1 bit and this flag is defined in the invention, together with the above-mentioned flag normal_complete_flag. The flag selected_complete_flag is a flag for controlling the movement of the animations when the button is changed from the selected state to another state. That is, the flag selected_complete_flag may be used in a case where the button is changed from the selected state to the activated state and changed from the selected state to the normal state.

As described above, when the value of the flag selected_complete_flag is “1”, the entire animations for the button defined as the selected state are displayed when the button is changed from the selected state to another state. More specifically, in a case where the value of the selected_complete_flag is “1” and it is instructed to change the state of the button from the selected state to another state in the process of displaying a selected state animation of the button, animations are displayed from the animation frame that is displayed at that moment up to the animation frame that is described in the field selected_end_object_id_ref.

Similarly, when the value of the flag selected_complete_flag is “1” and the flag selected_repeat_flag describes to repeat the animations (for example, the value of “1”), animations are displayed from the animation frame that is displayed at that moment up to the animation frame that is described in the field selected_end_object_id_ref.

In this case, even in a case where it is unable to select the button or the button display is disappeared, when the changing of these states occurs in the process of displaying the animations, the animations are displayed up to the animation frame that is described in the field selected_end_object_id_ref, and thereafter the state of the button is changed.

As a state where it is unable to select the button, for example, a case where selection of the button becomes unavailable due to the designation in the field selection_time out_pts or a case where the menu is automatically initialized by the designation in the field user_time_out_duration may be considered.

Meanwhile, in a case where the value of the flag selected_complete_flag is “0”, the animation display is stopped at a time being instructed to change the state of the button and the button in the another state is displayed on the screen, rather than displaying the animations for the buttons defined as the selected state up to the animation frame that is described in the field selected_end_object_id_ref when the button is changed from the selected state to another state.

In the next block activated_state_info( ), a flag representing whether to repeat the animations and a flag for controlling the movement of the animations when the button is changed from the activated state to the another state are not defined with respect to the above-mentioned blocks, namely, the block normal_state_info( ) and the block selected_state_info( ). After the button is changed to the activated state, the function assigned to the button is activated. Accordingly, it is considered that the time when the button is in the activated state is extremely short. It can be said that it is generally undesirable to change the state of the button being in the activated state to another state. Therefore, the above-mentioned flags are omitted from the block activated_state_info( ). It may be possible to define those flags in the block activated_state_info( ).

In the block activated_state_info( ), a field activated_state_sound_id_ref has a data length of 8 bits and represents a sound file that is reproduced with the button in the activated state. A field activated_start_object_id_ref and a field activated_end_object_id_ref have a data length of 16 bits, respectively, and represent an ID for designating the first and last objects of the animations of the buttons in the activated state, respectively.

Hereinabove, the block activated_state_info( ) has been described. The next field number_of_navigation_commands has a data length of 16 bits and represents the number of commands contained in the button. A loop beginning at the next for statement is repeatedly performed by the number of times described in the field number_of_navigation_commands. In this case, commands navigation_command( ) that is activated by the button is defined. In other words, it means that a plurality of commands can be activated by one button.

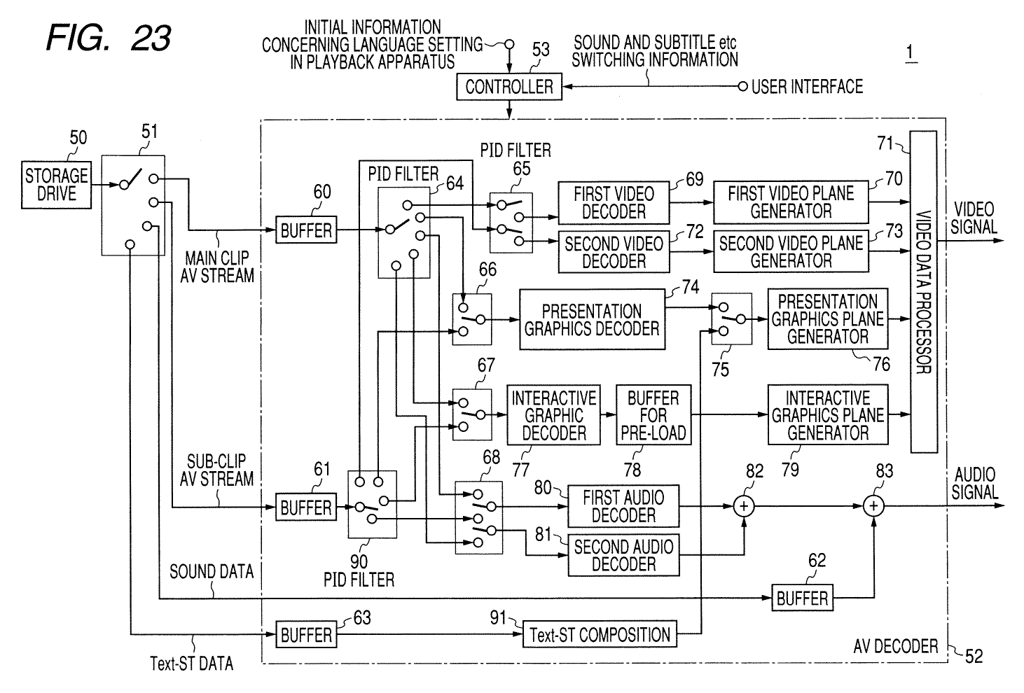

Next, a reproducing apparatus which is applicable to an embodiment of the invention will be described. FIG. 23 shows an exemplary configuration of the reproducing apparatus 1 which is applicable to the embodiment of the invention. The reproducing apparatus 1 includes a storage drive 50, a switch 51, an AV decoder 52, and a controller 53. It is assumed that the storage drive 50 is loaded with the BD-ROM described above and is capable of reproducing the BD-ROM.

The controller 53 is configured to include, for example, a CPU (Central Processing Unit), a ROM (Read Only Memory) on which programs running on the CPU is stored in advance, and a RAM (Random Access Memory) used as a work memory when executing programs by the CPU and control the entire operations of the reproducing apparatus 1.

Although not shown in drawing, the reproducing apparatus 1 is provided with a user interface which provides predetermined control information to the user and outputs a control signal in accordance with a user operation. For example, a remote controller performing a remote communication with the reproducing apparatus 1 through a predetermined wireless communication means such as infrared communication is used as the user interface. On the remote controller, a plurality of input units such as direction keys capable of designating up, down, left, and right directions, number keys, function keys assigned with predetermined various functions are provided.

The remote controller generates a control signal in accordance with operations by the input units, modulates the generated control signal into, for example, an infrared signal and transmits the infrared signal. The reproducing apparatus 1 receives the infrared signal by an infrared signal receiving unit (not shown), converts and demodulates the infrared signal into an electric signal, thereby recovering an original control signal. The control signal is supplied to the controller 53. The controller 53 controls the operation of the reproducing apparatus 1 in accordance with the program and the control signal.

The user interface is not limited to the remote controller described above, but may be constructed by a group of switches provided on an operation panel of the reproducing apparatus 1, for example. In addition, a communication means for performing a communication operation through a LAN (Local Area Network) may be provided to the reproducing apparatus 1 so as to supply signals supplied from external computing devices or like through the communication means to the controller 53 as a control signal from the user interface.

Initial information about language settings of the reproducing apparatus 1 is stored in a non-volatile memory installed in the reproducing apparatus 1. When the reproducing apparatus 1 is powered on, the initial information about the language settings is read from the memory and supplied to the controller 53.

When the disc is loaded into the storage drive 50, the controller 53 reads out a file index.bdmv or a file Movieobject.bdmv on the disc through the storage drive 50 and then reads out a play list file in a directory “PLAYLIST” on the basis of the read files. The controller 53 reads out a clip AV stream referenced by a play item contained in the play list file from the disc through the storage drive 50. Moreover, when the play list includes a sub play item, the controller 53 may read out the clip AV stream or subtitle data referenced by a sub play item from the disc through the storage drive 50.

Hereinafter, the clip AV stream correlated with the sub play item will be referred to as a sub clip AV stream and the clip AV stream correlated with a main play item of the sub play item will be referred to as a main clip AV stream.

Data that is output from the storage drive 50 is subjected to a predetermined demodulation process and a predetermined error correction process by a demodulation unit (not shown) and an error correction unit (not shown), thereby outputting a multiplexed stream. The multiplexed stream is a transport stream in which the type or arrangement order of data is identified by the PID and the data is divided into a predetermined size and multiplexed in a time divisional method. The multiplexed stream is supplied to the switch 51. The controller 53 controls the switch 51 in a predetermined manner on the basis of the PID, for example, so as to classify the data based on a respective type thereof, supply a packet of the main clip AV stream to a buffer 60, supply a packet of the sub clip AV stream to a buffer 61, supply a packet of sound data to a buffer 62, and supply a packet of text data to a buffer 63.

The packets of the main clip AV stream contained in the buffer 60 are read out in units of a packet in accordance with the control of the controller 53 and supplied to the PID filter 64. The PID filter 64 classifies the packets into a packet of the video stream, a packet of the presentation graphics stream (hereinafter, referred to as PG stream), a packet of the interactive graphics stream (hereinafter, referred to as IG stream), and a packet of the audio stream, on the basis of the PID of the supplied packets.

Meanwhile, the packets of the sub clip AV stream contained in the buffer 61 are read out in units of packet in accordance with the control of the controller 53 and supplied to the PID filter 90. The PID filter 90 classifies the packets into a packet of the video stream, a packet of the PG stream, a packet of the IG stream, and a packet of the audio stream, on the basis of the PID of the supplied packets.

The packets of the video stream classified by the PID filter 64 and the packets of the video stream classified by the PID filter 90 are supplied to a PID filter 65 and classified in accordance with the PID. That is, the PID filter 65 classifies the packets so as to supply the packets of the main clip AV stream supplied from the PID filter 64 to a first video decoder 69 and supply the packets of the sub clip AV stream supplied from the PID filter 90 to a second video decoder 72.

The first video decoder 69 extracts a video stream from the payload of the supplied packets in a predetermined manner and decodes the extracted video stream that is compression-encoded in accordance with MPEG2. The output from the first video decoder 69 is supplied to a first video plane generator 70 and a video plane is generated. The video plane is generated when one frame of base-band digital video data, for example, is written to a frame memory. The video plane generated in the first video plane generator 70 is supplied to a video data processor 71.

In a second video decoder 72 and a second video plane generator 73, substantially the same operations as the first video decoder 69 and the first video plane generator 70 are performed, the video stream is decoded, and the video plane is generated. The video plane generated in the second video plane generator 73 is supplied to the video data processor 71.

The video data processor 71 combines the video plane generated by the first video plane generator 70 and the video plane generated by the second video plane generator 73 into a single frame in a predetermined manner and outputs the combined plane as a single page of video plane. The video plane generated by the first video plane generator 70 and the video plane generated by the second video plane generator 73 may be selectively used as a video plane. The video plane corresponds to for example the moving picture plane 10 described with relation to FIG. 9.

The packets of the PG stream classified by the PID filter 64 and the packets of the PG stream classified by the PID filter 90 are supplied to the switch 66 which selects one of the packets in a predetermined manner and supplies the selected packets to the presentation graphics decoder 74. The presentation graphics decoder 74 extracts and decodes the PG streams from the payload of the supplied packets in a predetermined manner, generates graphics data for displaying subtitles, and supplies the graphics data to the switch 75.

The switch 75 selects one of the graphics data and text subtitle data to be described later in a predetermined manner and supplies selected data to the presentation graphics plane generator 76. The presentation graphics plane generator 76 generates a presentation graphics plane on the basis of the supplied data and supplies the generated presentation graphics plane to the video data processor 71. The presentation graphics plane corresponds to the subtitle plane 11 described with relation to FIG. 9.

The packets of the IG stream classified by the PID filter 64 and the packets of the IG stream classified by the PID filter 90 are supplied to the switch 67 which selects one of the packets in a predetermined manner and supplies the selected packets to the interactive graphics decoder 77. The interactive graphics decoder 77 extracts and decodes the segments, namely, ICS, PDS, and ODS, of the IG streams from the packets of the supplied IG streams. For example, the interactive graphics decoder 77 extracts data from the payload of the supplied packets and reconstructs the PES packet. In this case, the segments, namely, ICS, PDS, and ODS of the IG streams are extracted on the basis of the header information of the PES packet. The decoded ICS and PDS are stored in a buffer called a CB (Composition Buffer). The ODS is stored in a buffer called a DB (Decoded Buffer). For example, a preload buffer 78 in FIG. 23 corresponds to these buffers, namely, CB and DB.

The PES packet includes a PTS (Presentation Time Stamp) that represents time management information for reproduction and a DTS (Decoding Time Stamp) that represents time management information for decoding. The menu display with the IG stream is performed in accordance with the PTS stored in the corresponding PES packet and the time for displaying the menu is controlled by the PTS. For example, each data constituting the IG stream stored in the above-mentioned preload buffer is controlled such that the data is read out from the preload buffer at a predetermined time in accordance with the PTS.

The IG stream data read from the preload buffer 78 is supplied to the interactive graphics plane generator 79 which generates the interactive graphics plane. The interactive graphics plane corresponds to the graphics plane 12 described with relation to FIG. 9.

When a button to be displayed is in the normal state, the interactive graphics decoder 77 updates animation frames including from the animation frame described in the field normal_start_object_id_ref up to the animation frame described in the field normal_end_object_id_ref in the block button( ) described in FIG. 22, in units of a frame, on the basis of a value described in the field animation_frame_rate_code described in FIG. 20, whereby the animations for the buttons are displayed. The animation display can be stopped by stopping the updating of frames at an arbitrary timing.

The video data processor 71 includes the graphics processor described with relation to FIG. 11 and is configured to combine the supplied video plane (the moving picture plane 10 in FIG. 11), the presentation graphics plane (the subtitle plane 11 in FIG. 11), and the interactive graphics plane (the graphics plane 12 in FIG. 11) into a page of image data in a predetermined manner and output the combined planes as a video signal.

The audio stream classified by the PID filter 64 and the audio stream classified by the PID filter 90 are supplied to the switch 68. The switch 68 selects one of the supplied audio streams in a predetermined manner so as to supply one of two sets of the supplied audio streams to a first audio decoder 80 and the other audio stream to a second audio decoder 81. Audio streams decoded by the first audio decoder 80 and the second audio decoder 81 are combined by an adder 82 and are combined with the sound data read out from the buffer 62 by an adder 83 and are output therefrom.

Text data read out from the buffer 63 is subjected to a predetermined process in a Text-ST composition unit and supplied to the switch 75.

In the foregoing description, each portion of the reproducing apparatus 1 is composed of hardware. However, the invention is not limited to such an example. For example, the reproducing apparatus 1 can be accomplished by a process of software. In this case, the reproducing apparatus 1 can be operated on a computer device. The reproducing apparatus 1 can be accomplished by a combination of hardware and software. For example, in the reproducing apparatus 1, the first video decoder 69 and the second video decoder 72 which has a relatively great processing load may be composed of hardware, and the rest of the decoders may be composed of software.

A program that causes a computer device to execute the reproducing apparatus 1 composed of only software or a combination of hardware and software is recorded on a recording medium such as a CD-ROM (Compact Disc-Read Only Memory) and a DVD-ROM (Digital Versatile Disc Read Only Memory) and supplied therewith. The recording medium is loaded into a drive of the computer device, and the program recorded on the recording medium is installed to the computer device in a predetermined manner. As a result, the foregoing process can be executed on the computer device. The program may be recorded on a BD-ROM. Since the structure of the computer device is well known, the description thereof will be omitted.

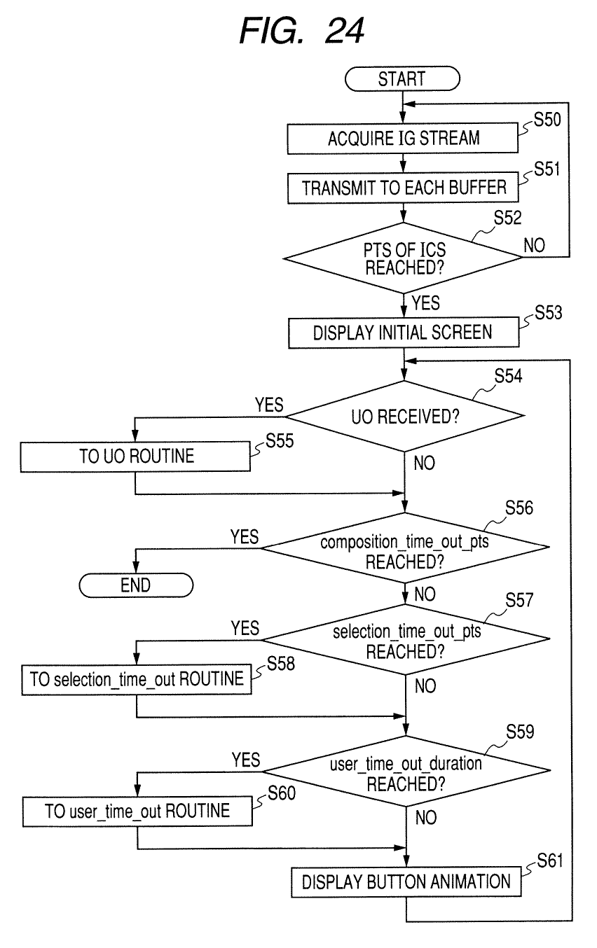

Next, an operation of controlling the button display in the menu display according to an embodiment of the invention will be described with reference to flowcharts of FIGS. 24 to 27. The processes in the flowcharts of FIGS. 24 to 27 are performed by the interactive graphics decoder 77. However, the invention is not limited to such an example. The interactive graphics decoder 77 may perform the processes in cooperation with the controller 53, or the controller 53 may controls the entire processes.

FIG. 24 is a flowchart showing an example of processes that are performed until a displayed menu screen is removed after acquiring IG stream. First, in step S50, the interactive graphics decoder 77 (hereinafter, referred to as IG decoder 77) acquires the IG stream. The IG decoder 77 extracts segments, namely, ICS, PDS, and ODS, from the acquired IG stream and stores the extracted segments to corresponding buffers (step S51). When it is reached to a time described in the PTS of the ICS (step S52), an initial screen of the menu screen is displayed in accordance with the acquired IG stream (step S53).

In the initial screen, as described with relation to FIG. 20, among those buttons displayed on the menu screen, one or more button(s) that is represented by the field default_selected_button_id_ref is in the selected state in advance. When the button is configured to be displayed with animations for the selected state, the initial screen is displayed with the animations. When the buttons in the normal state are configured to be displayed with animations thereof, the initial screen is displayed with the animations.

In step S54, it is determined whether the controller 53 has received a user operation (UO). For example, when a user has operated any operation to the remote controller, a control signal corresponding to the user operation is supplied to the controller 53 from the user interface. The controller 53 notifies the IG decoder 77 of the receipt of the UO in accordance with the control signal. When it is determined that the UO is received by the controller 53, the procedure proceeds to a process routine (a UO routine) of step S55 which is performed when the UO is received. After completing the process routine of step S55, a process of step S56 is performed.

Meanwhile, when it is determined in step S54 that the UO is not received, it is determined in step S56 whether it is reached to a time described in the field composition_time_out_pts described in FIG. 19. The time is determined on the basis of the time described in the PTS of the ICS determined in step S52, for example. When it is determined that it is reached to the time, the menu is removed from the screen and the above-mentions processes are completed.

When it is determined in step S56 that it is not reached to the time described in the field composition_time_out_pts, a process of step S57 is performed. In step S57, it is determined whether it is reached to a time described in the field selection_time_out_pts that is described in FIG. 19. When it is determined that it is reached to the time, the procedure proceeds to a process routine (a selection_time_out routine) of step 58 which is performed when it is reached to the time described in the field selection_time_out_pts. After completing the process routine of step S58, a process of step S59 is performed.

Meanwhile, when it is determined in step S57 that it is not reached to the time described in the field selection_time_out_pts, it is determined in step S59 whether it is reached to the time described in the field user_time_out_pts described in FIG. 19. When it is determined that it is reached to the time, the procedure proceeds to a process routine (a user_time_out routine) of step S60 which is performed when it is reached to the time described in the field user_time_out_pts. After completing the process routine of step S60, a predetermined button animation is displayed on the screen in step S61. Then, the process of step S54 is performed again, in which it is determined whether the UO is received.

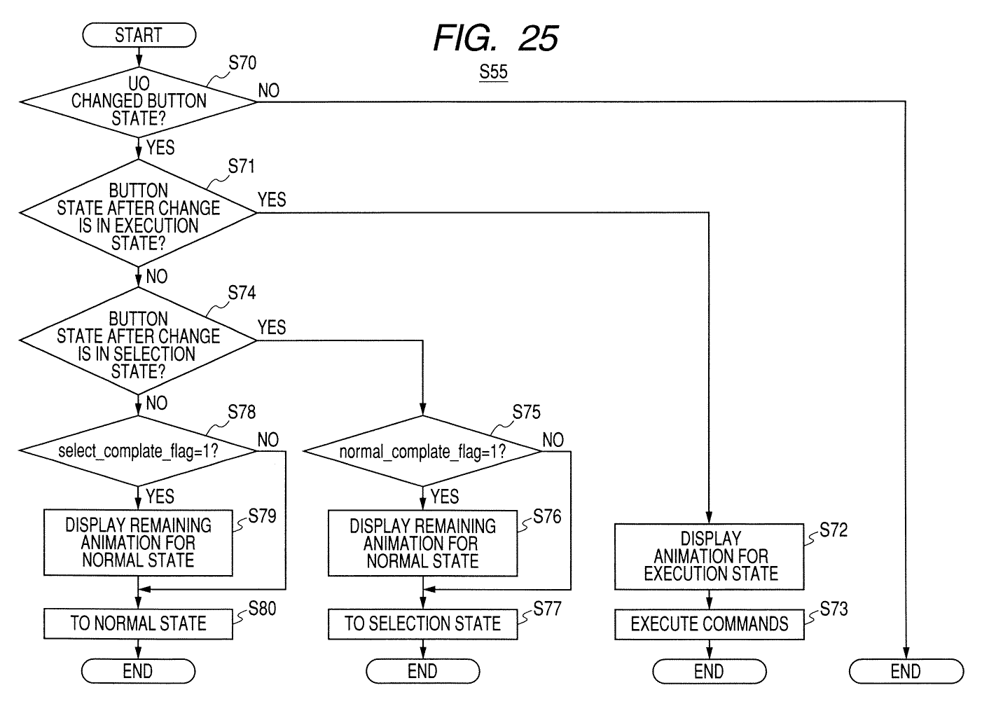

FIG. 25 is a flowchart showing a specific example of processes in the “UO routine” of step S55. First, in step S70, it is determined whether the UO received in step S54 instructs to change the button state displayed on the menu screen. When it is determined that the received UO does not instruct to change the button state, the process of step S56 in FIG. 24 is performed without performing the processes in the flowchart of FIG. 25.

When it is determined in step S70 that the received UO instructs to change the button state, it is determined in step S71 whether the button state changed in accordance with the UO corresponds to the activated state.

For example, when the user operates the remote controller to designate the selected state of a button by pressing an OK button of the remote controller in a state that the button is in the selected state, the state of the button is changed from the selected state to the activated state. Meanwhile, when the user operates the remote controller to designate the selected state of another button by pressing direction keys of the remote controller capable of designating up, down, left, and right directions in a state that the button is in the selected state, the state of the button is changed from the selected state to the normal state and the state of the another button is changed from the normal state to the selected state.

When it is determined in step S71 that the state of the button is changed to the activated state, the button is displayed with animations for the activated state in step S72. As described with relation to FIG. 22, the animation for the activated state are displayed from the beginning animation frame that is described in the field activated_start_object_id_ref up to the ending animation frame that is described in the field activated_end_object_id_ref, which are described for the button in the activated state. After displaying the animations, a command embedded to the button is executed. When the command is executed, the process of step S56 in FIG. 24 is performed without performing the processes in the flowchart of FIG. 25.

Meanwhile, when it is determined in step S71 that the state of the button is not changed to the activated state, it is determined in step S74 whether the state of the button is changed to the selected state. When it is determined that the state of the button is changed to the selected state, a process of step S75 is performed. It means that the button is presently in the normal state and will be changed to the selected state in accordance with the UO.

In step S75, the value of the flag normal_complete_flag is determined. When it is determined that the value of the flag normal_complete flag is “1”, the button is displayed with animations in step S76 up to the animation frame that is described in the field normal_end_object_id_ref. Then, the state of the button is changed to the selected state in step S77.

When the state of the button is changed to the selected state in step S77, the process of step S56 in FIG. 24 is performed without performing the processes in the flowchart of FIG. 25.

Meanwhile, when it is determined that the value of the flag normal_complete_flag is “0”, the process of step S77 is performed, in which the animations being displayed for the button is stopped and the state of the button is changed to the selected state.

States of the menu screen may be stored in a RAM installed in the controller 53. The states of the menu screen may be stored in a non-volatile memory installed in the reproducing apparatus 1. Information about the menu screen, such as information representing the page number of the menu screen, IDs of the buttons displayed on the menu screen, and present states of the buttons, are stored in the memory and monitored by the controller 53 or the like.

When it is determined in step S74 that the state of the button is not changed to the selected state, a process of step S78 is performed. It means that the button is presently in the selected state and will be changed to the normal state in accordance with the UO.

In step S78, the value of the flag selected_complete_flag is determined. When it is determined that the value of the flag selected_complete_flag is “1”, the button is displayed with animations in step S79 up to the animation frame that is described in the field selected_end_object_id_ref. Then, the state of the button is changed to the normal state in step S80.

Meanwhile, when it is determined that the value of the flag selected_complete_flag is “0”, the process of step S80 is performed, in which the animations being displayed for the button is stopped and the state of the button is changed to the normal state.

When the state of the button is changed to the normal state in step S80, the process of step S56 in FIG. 24 is performed without performing the processes in the flowchart of FIG. 25.

In this way, according to the embodiment of the invention, there is provided a flag for designating whether to continue to display the animations till the last or stop to display the animations when the user has instructed to change state of the button in the process of displaying the animations of the button. Accordingly, it is possible for a contents producer to control the display of the animations when receiving the user operation.

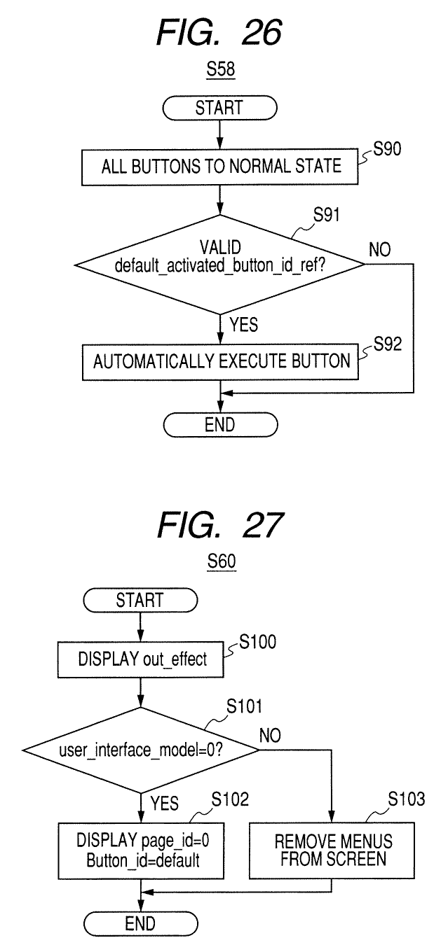

FIG. 26 is a flowchart showing a specific example of processes in the “selection_time_out routine” of step S58. First, in step S90, the states of the entire buttons presently displayed on the menu screen are changed to the normal state. Next, it is determined in step S91 whether the field default_activated_button_id_ref described in FIG. 20 is set to a valid value. When it is determined that the field default_activated_button_id_ref is set to an invalid value, the process of step S59 in FIG. 24 is performed without performing the processes in the flowchart of FIG. 26.

Meanwhile, when it is determined in step S91 that the field default_activated_button_id_ref is set to an invalid value, the button that is described in the field default_activated_button_id_ref is automatically activated in step S92. That is, the button is automatically changed to the activated state and commands set to the button is automatically executed. Moreover, the process of step S59 in FIG. 24 is performed without performing the processes in the flowchart of FIG. 26.

FIG. 27 is a flowchart showing a specific example of processes in “user_time_out routine” in step S60. First, in step S100, animations corresponding to the end of the menu screen, which are defined for the presently displayed page and described in the block out_effect( ) described with relation to FIG. 20, is displayed on the screen. Next, in step S101, on the basis of the value of the field user_interface_model described with relation to FIG. 19, it is determined whether the menu screen defined in the IG stream including the ICS for the present menu screen is a popup menu or a normal menu.

When it is determined to be the popup menu (i.e., when the value of the field user_interface_model is “1” 1), a process of step S103 is performed. In step S103, the menu is removed from the screen, and the process of step S61 is performed without performing the processes in the flowchart of FIG. 27. Meanwhile, when it is determined to be the normal menu, a default menu screen for the IG stream is displayed on the screen in step S102. For example, in the menu screen of the initial page (i.e., the value of the field page_id is “0”), the states of the buttons displayed on the menu screen are initialized (the value of the field button_id for the entire buttons displayed on the menu screen is “default”). Thereafter, the process of step S61 is performed without performing the processes in the flowchart of FIG. 27.

When the process of step S61 is performed after removing the menu from the screen in step S103, animations are not displayed on the screen.

In the foregoing description, the IG stream related to the embodiment of the invention is recorded in advance on the disc. However, the invention is not limited to such an example. That is, the reproducing apparatus 1 may acquire the IG stream itself, the segments ICS, PGS, and ODS that constitute the IG stream, and parameters defined in the ICS through a network called internet.

As an example, the reproducing apparatus 1 may include a communication interface that can communicate with the internet. When a disc is being reproduced, the communication interface may communicate with a server or the like through Internet so as to acquire the ICS from the IG stream corresponding to the disc by downloading the IG stream from the internet. The acquired ICS is input to the switch 51 and supplied to the interactive graphic decoder 77 through a predetermined path. In this way, it is possible to acquire the IG stream or the ICS from the internet rather than acquiring the IG stream or the ICS from the disc. In this case, only the IG stream or the IG stream and picture data reproduced in synchronism with the IG stream are recorded on a hard disc or the like as a transport stream and are reproduced simultaneously with video data recorded on the disc using the above-mentioned sub play item.

The invention is not limited to such an example. The IG stream itself, the segments ICS, PGS, and ODS that constitute the IG stream, and parameters defined in the ICS may be acquired from another recording medium different from the disc having the contents recorded thereon. In this case, the reproducing apparatus 1 is connected to a drive corresponding to the used recording medium.

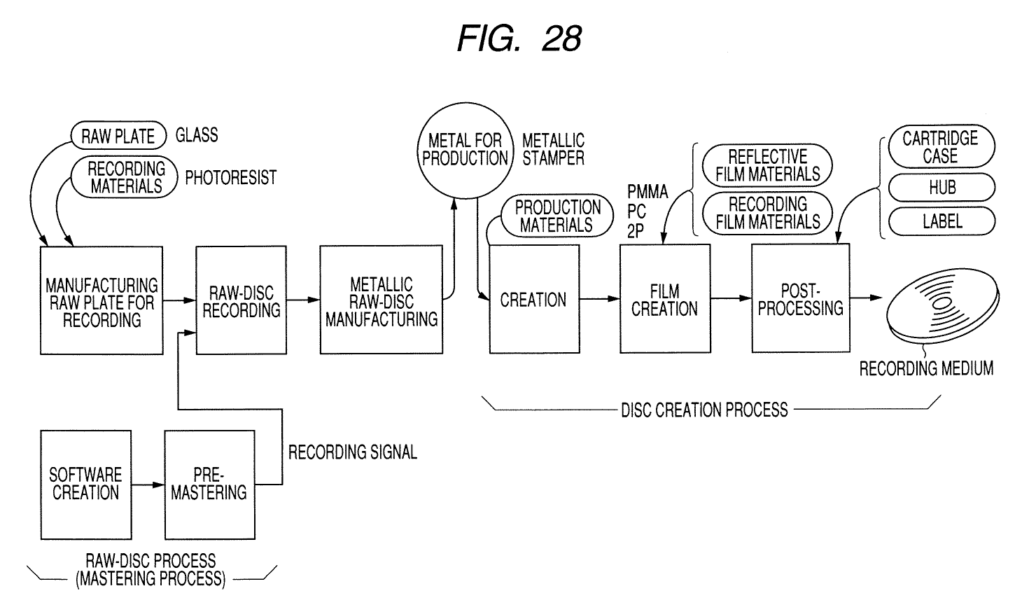

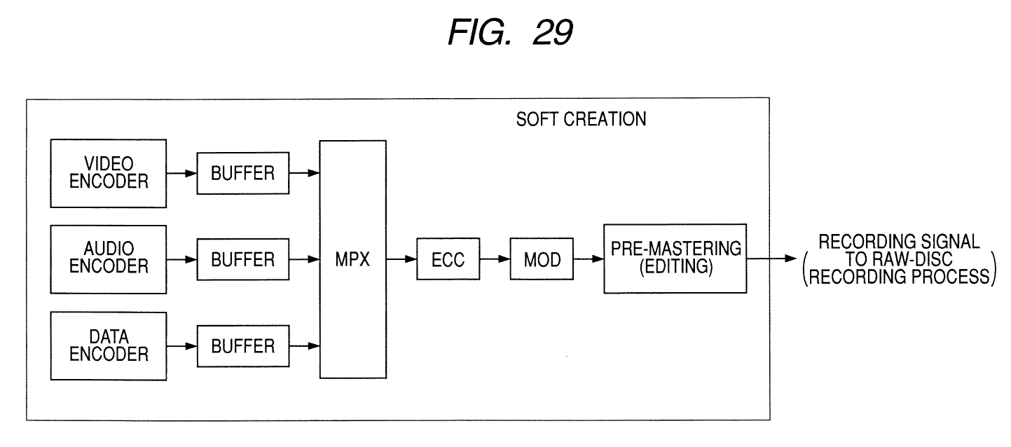

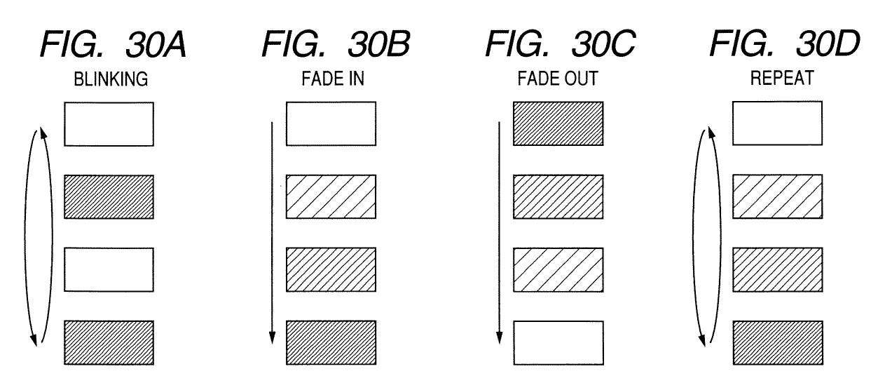

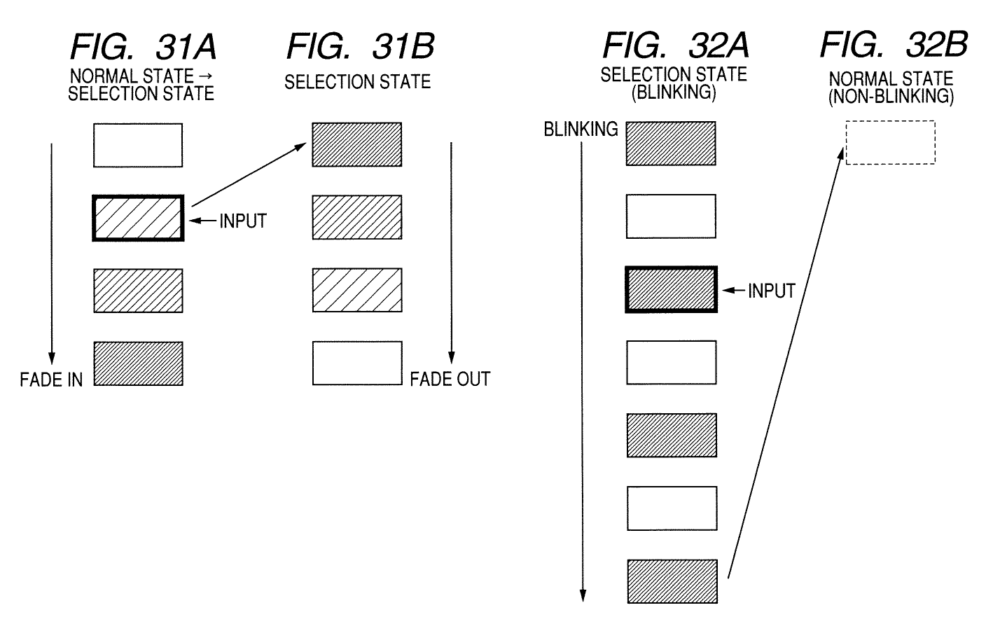

A method of manufacturing a disc that can be reproduced by the reproducing apparatus 1 described above will be described with reference to FIGS. 28 and 29. As shown in FIG. 28, a raw disc made of glass or the like is prepared, and the surface of the raw disc is coated with a recording material made of a photo-resist or the like, thereby producing a raw disc for recording.

As shown in FIG. 29, in a software creation unit, video data encoded by an encoding device (a video encoder) and having a format that can be reproduced by the reproducing apparatus 1 is stored in a temporary buffer, and audio data encoded by an audio encoder is stored in a temporary buffer. Moreover, the presentation graphics data and the interactive graphics data are encoded in a predetermined manner and stored in a temporary buffer. The interactive graphics data may include the above-mentioned flags, namely, select_complete_flag and normal_complete_flag. Moreover, non-stream data (for example, index, play list, play item, and the like) encoded by a data encoder is stored in a temporary buffer.

The video data, the audio data, the presentation graphics data, the interactive graphics data, and the non-stream data, stored in the respective buffers, are multiplexed with a synchronization signal by a multiplexer (MPX). Error-correction codes are then added to the output of the multiplexer (MPX) by an error correction circuit (ECC). Subsequently, the output of the error correction circuit ECC undergoes predetermined modulation in a modulator MOD. The modulated data output by the modulator MOD is temporarily recorded on a magnetic tape or the like in a predetermined format, thereby producing software to be stored on a recording medium that can be reproduced by the reproducing apparatus 1.

The software creation unit may be constructed in a computing device known in the art, and the entire operations of the software creation unit may be controlled by a CPU or the like in accordance with a predetermined program. The program may be recorded on a recording medium such as CD-ROM or DVD-ROM and supplied therewith. The recording medium having the program recorded thereon is loaded into the computer device, and the program is installed to a system of the computer device in a predetermined manner. As a result, the software creation unit can be embodied in the computer device.

If necessary, the software may be edited (a pre-mastering process) to produce a formatted signal that can be recorded on a disc. A laser beam is modulated in accordance with the formatted recording signal, and then applied to the photo-resist on the raw disc. In this way, the photo-resist on the raw disc is subjected to an exposure process with the recording signal.

Thereafter, the raw disc is developed, causing pits to appear on the surface of the raw disc. The raw disc is subjected to an electro-casting process to transfer the pits on the glass raw disc to a metallic raw disc. A metallic stamper is further produced from the metallic raw disc to be used as a mold.

A material such as PMMA (polymethyl methacrylate) or PC (polycarbonate) is then poured into the mold through an injection process and hardened therein. Alternatively, the metallic stamper can be coated with an ultraviolet-ray curable resin such as 2P and then exposed to ultraviolet radiation for hardening it. In this way, the pits are transferred from the metallic stamper to the replica made of resin.

Subsequently, a reflective film is created on the replica produced in the processes described by deposition, sputtering or the like. As an alternative, a spin-coating process can also be used to create such a reflective film on the replica.

Thereafter, the raw disc then undergoes a machining process to trim the raw disc to its diameter as well as any other necessary processing, for example, to attach one raw disc to another back-to-back. Further, a label and a hub are affixed thereon and the raw disc is put in a cartridge. In this way, a disc having data recorded thereon that can be reproduced by the reproducing apparatus 1 is obtained.

It should be understood by those skilled in the art that various modifications, combinations, sub-combinations and alterations may occur depending on design requirements and other factors insofar as they are within the scope of the appended claims or the equivalents thereof.

What is claimed is:

1. A reproducing device which reproduces contents data recorded on a disc-shaped recording medium, the reproducing device comprising:
an input unit which inputs data including at least the contents data, button images capable of displaying animations of buttons used in an operation screen that prompts a user to perform an operation, and display control information for the button images, the contents data, the button images and the display control information are reproduced from the recording medium;
an operation input unit which receives the user operation; and
a display controller which controls a display of the animations of the button images on the basis of the display control information,
wherein the display control information includes an animation display control flag indicating whether to stop displaying the animations of the button images when the user has instructed to change states of the buttons corresponding to the button images in the process of displaying the animations of the button images, and
wherein the display controller stops displaying the animations of the button images in accordance with the indication of the animation display control flag when receiving the user's operation for changing the states of the buttons corresponding to the button images from the operation input unit in the process of displaying the animations of the button images.

2. The reproducing device according to claim 1, wherein the animation display control flag is set for each button.

3. The reproducing device according to claim 1,
wherein the states of the buttons include a first state representing that assigned functions are instructed to be activated, a second state representing that the assigned functions are selected, and a third state representing a state other than the first and second states, and
wherein the animation display control flag is set for each of the second and third states.

4. The reproducing device according to claim 1, wherein the display controller continues to display the animations even when it is instructed to remove the button images in the process of displaying the animation of the button images which are instructed to continue to display the animation by the animation display control flag.

5. The reproducing device according to claim 1, wherein the display controller continues to display the animations even when it is instructed to invalidate the button images in the process of displaying the animation of the button images which are instructed to continue to display the animation by the animation display control flag.

6. The reproducing device according to claim 1,
wherein at least button images which are first and last used in the process of displaying the animations are designated as the display control information, and
wherein the display controller continues to display the animations of the button images, which are indicated to continue to display the animations by the animation display control flag and are designated to repeat the display of the animations, up to the last-used button image which is designated by the display control information.

7. A reproducing method of reproducing contents data recorded on a disc-shaped recording medium, the recording method comprising the steps of:
inputting data including at least the contents data, button images capable of displaying animations of buttons used in an operation screen that prompts a user to perform an operation, and display control information for the button images, the contents data, the button images and the display control information are reproduced from the recording medium;
receiving the user operation; and
controlling animation display of the button images on the basis of the display control information,
wherein the display control information includes an animation display control flag indicating whether to stop displaying the animations of the button images when the user has instructed to change states of the buttons corresponding to the button images in the process of displaying the animations of the button images, and
wherein the controlling stops displaying the animations of the button images in accordance with the indication of the animation display control flag when receiving the user's operation for changing the states of the buttons corresponding to the button images in the receiving in the process of displaying the animations of the button images.

8. A reproducing program for causing a computer device to execute a reproducing method of reproducing contents data recorded on a disc-shaped recording medium, the reproducing method comprising the steps of:
inputting data including at least the contents data, button images capable of displaying animations of buttons used in an operation screen that prompts a user to perform an operation, and display control information for the button images, the contents data, the button images and the display control information are reproduced from the recording medium;
receiving the user operation; and
controlling animation display of the button images on the basis of the display control information,
wherein the display control information includes an animation display control flag indicating whether to stop displaying the animations of the button images when the user has instructed to change states of the buttons corresponding to the button images in the process of displaying the animations of the button images, and
wherein the controlling stops displaying the animations of the button images in accordance with the indication of the animation display control flag when receiving the user's operation for changing the states of the buttons corresponding to the button images in the receiving in the process of displaying the animations of the button images.

9. A disc-shaped recording medium on which contents data has been recorded,
wherein at least the contents data, button images capable of displaying animations of buttons used in an operation screen that prompts a user to perform an operation, and display control information for the button images are recorded on the recording medium, and
wherein the display control information includes an animation display control flag indicating whether to stop displaying the animations of the button images when the user has instructed to change states of the buttons corresponding to the button images in the process of displaying the animations of the button images.

10. The disc-shaped recording medium according to claim 9, wherein the animation display control flag is set for each button.

11. The disc-shaped recording medium according to claim 9,
wherein the states of the buttons include a first state representing that assigned functions are instructed to be activated, a second state representing that the assigned functions are selected, and a third state representing a state other than the first and second states, and
wherein the animation display control flag is set for each of the second and third states.

12. A data structure which includes at least contents data, button images capable of displaying animations of buttons used in an operation screen that prompts a user to perform an operation, and display control information for the button images,
wherein the display control information includes an animation display control flag indicating whether to stop displaying the animations of the button images when the user has instructed to change states of the buttons corresponding to the button images in the process of displaying the animations of the button images.

13. An authoring device which creates contents data to be recorded on a disc-shaped recording medium, the authoring device comprising:
a data creating unit which creates a data structure including at least the contents data, button images capable of displaying animations of buttons used in an operation screen that prompts a user to perform an operation, and display control information for the button images,
wherein the data creating unit allows the display control information to include an animation display control flag indicating whether to stop displaying the animations of the button images when the user has instructed to change states of the buttons corresponding to the button images in the process of displaying the animations of the button images.

14. An authoring method of creating contents data to be recorded on a disc-shaped recording medium, the authoring method comprising a step of:
creating a data structure including at least the contents data, button images capable of displaying animations of buttons used in an operation screen that prompts a user to perform an operation, and display control information for the button images,
wherein the creating allows the display control information to include an animation display control flag indicating whether to stop displaying the animations of the button images when the user has instructed to change states of the buttons corresponding to the button images in the process of displaying the animations of the button images.

15. An authoring program for causing a computer device to execute an authoring method of creating contents data to be recorded on a disc-shaped recording medium, the authoring method comprising a step of:
creating a data structure including at least the contents data, button images capable of displaying animations of buttons used in an operation screen that prompts a user to perform an operation, and display control information for the button images,
wherein the creating allows the display control information to include an animation display control flag indicating whether to stop displaying the animations of the button images when the user has instructed to change states of the buttons corresponding to the button images in the process of displaying the animations of the button images.
